(19) United States
(12) Patent Application Publication
(10) Pub. No.: US 2006/0227671 A1
(43) Pub. Date: Oct. 12, 2006

(54) Content distribution system, content providing medium production method, content acquisition apparatus, and content aquisition method

(75) Inventors: Minoru Tobita, Tokyo (JP); Yoshiyuki Teraoka, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/392,690

(22) Filed: Mar. 30, 2006

(30) Foreign Application Priority Data
Apr. 11, 2005 (JP) 2005-113198

(51) Int. Cl. G11B 21/08

(52) U.S. Cl. 369/30.01

(57) ABSTRACT

A system is disclosed wherein a content is distributed without using a network. The distributed content is acquired and reproduced by a content acquisition apparatus.

### CROSS REFERENCES TO RELATED APPLICATIONS

The present invention contains subject matter related to Japanese Patent Application JP 2005-113198, filed in the Japanese Patent Office on Apr. 11, 2005, the entire contents of which being incorporated herein by reference.

### BACKGROUND OF THE INVENTION

This invention relates to a distribution system for content data, and a production method for a content providing medium used to compose the distribution system, a content acquisition apparatus and a content acquisition method.

When a user wants to acquire a favorite music content, video content or like content, the user usually purchases a package medium such as, for example, a CD (Compact Disc; trademark), a DVD (Digital Versatile Disc; trademark) or an MD (Mini Disc; trademark).

Further, in recent years, electronic music distribution called EMD (Electronic Music Distribution) has been put into practical use such that a user can download a desired content through network environments such as the Internet to acquire the content.

### SUMMARY OF THE INVENTION

The EMD provides enhanced convenience in that a user can purchase a music content or the like without deliberately going to a shop and can purchase only one favorite tune. However, in order for a user to utilize the EMD, preferably the user has high-speed network environments, and not all people can readily enjoy the convenience of the EMD.

For example, even where a music content is in a compressed state, if the play time of the music content is five minutes at 64 kbps, then the amount of data to be downloaded is 2.4 MB. Even if a modem of 64 kbps is used, five minutes are required for downloading transfer of the music content, and a user who does not have high-speed line environments such as the ADSL or an optical fiber may feel that a very long period of time is required.

Further, since a personal computer is used for such downloading, when the user tries to utilize the EMD, naturally the user must activate the personal computer and must make a search in order to find whether or not a favorite tune is available on a web site.

In other words, a music content is not in a situation wherein it is noticed readily by a user like a poster or an advertisement of a magazine, and it is necessary for a user to act to positively search for a music content. For example, where a poster, a book or the like has an introduction of a music content or the like thereon and a user notices the introduction and wants to acquire the music content or the like, the user cannot immediately acquire the music content or the like readily.

Further, while it is demanded frequently to reproduce a music content or the like on an AV apparatus such as a portable player, where a music content is downloaded using a personal computer, the content must be moved to the portable player or the like. Alto this requires much time.

Meanwhile, such two-dimensional barcodes as represented by the QR code (trademark) have been popularized, and various kinds of information can be acquired by reading a two-dimensional barcode printed on a book or the like using an optical reader apparatus or a portable telephone set having a reader function as disclosed, for example, in Japanese Patent Laid-open No. 2002-91431 (hereinafter referred to as Patent Document 1).

However, the capacity of a two-dimensional barcode is approximately several hundreds bytes, and a music or video content of sufficiently high quality for distribution cannot be recorded as a two-dimensional barcode.

In the present situation, if it is tried to distribute music using a two-dimensional barcode, then, for example, address information such as a URL (Uniform Resource Location) of a distribution web site or the like is recorded in the two-dimensional barcode. Then, a user would access the URL read from the two-dimensional barcode to download desired music into a portable telephone set, a personal computer or a like device. In this instance, although the time and labor required to search for the web site is eliminated, a large amount of content data itself is downloaded through network communication after all. Accordingly, the drawback that high-speed communication environments are essentially required in order to prevent users from feeling stress is not eliminated.

Naturally, it is possible to record music data or the like as a two-dimensional barcode. However, from the problem of the capacity, the data which can be recorded as a two-dimensional barcode is limited to data only for a considerably short period of time (for example, only part of a tune) or to data of low sound quality. In this manner, it is difficult to establish a distribution service of a content itself such as, for example, a music content or a video content only with a two-dimensional barcode.

It is desirable for the present invention to provide a content distribution system wherein a user can receive distribution of a content such as a music content or a video content without feeling a stress even if high-speed network environments are not available and a production method for a content providing medium used to compose the distribution system, a content acquisition apparatus and a content acquisition method.

In order to attain the desire described above, according to an embodiment of the present invention, there is provided a content distribution system including a content providing medium having a hologram memory in which content data is recorded as distribution data, and an acquisition apparatus for reading out and acquiring the distribution data from the hologram memory provided on the content providing medium.

According to another embodiment of the present invention, there is provided a content providing medium production method including the steps of converting content data into hologram master data, producing a master recording medium using the hologram master data, and producing providing medium, for duplicating a hologram memory from the master recording medium and providing a predetermined content providing medium with the fabricated hologram memory.

According to a still further embodiment of the present invention, there is provided a content acquisition apparatus for acquiring content data from a content providing medium having a hologram memory in which the content data is recorded as distribution data, including reference light outputting means for outputting reading out reference light to the hologram memory on the content recording medium, detection means for detecting, in a state wherein the reading out reference light is applied to the hologram memory by the reference light outputting means, a reproduction image based on data recorded in the hologram memory, and reproduction processing means for reproducing a data string as the content data from the reproduction image detected by the detection means.

According to a still further embodiment of the present invention, there is provided a content acquisition method for acquiring content data from a content providing medium having a hologram memory in which the content data is recorded as distribution data, including the steps of detecting, in a state wherein reading out reference light is applied to the hologram memory on the content providing medium, a reproduction image of data recorded in the hologram memory, and reproducing a data string as the content data from the reproduction image detected at the detection step.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic view of a download system to which the present invention is applied;

FIG. 2 is a block diagram showing a content providing medium production system to which the present invention is applied;

FIGS. 3A and 3B are schematic views each illustrating a data block as a recording unit of content data;

FIG. 4A is a schematic view illustrating an example of two-dimensional images recorded in a hologram memory;

FIG. 4B is a schematic view illustrating recording of content data into the hologram memory;

FIG. 5 is a schematic view showing reproduced images of the hologram memory;

FIG. 6 is a block diagram of a hologram master production apparatus to which the present invention is applied;

FIG. 7A is a schematic view of an optical system of a holographic stereogram printer apparatus for forming a hologram master to which the present invention is applied as viewed from sidewardly;

FIG. 7B is a schematic view of the optical system of the holographic stereogram printer as viewed from above;

FIG. 8A is a schematic perspective view showing an appearance of an example of a hologram reproduction apparatus to which the present invention is applied and in which a reference light emitting section is fixed while an image pickup section is moved;

FIG. 8B is a similar view but showing an appearance of another example of the hologram reproduction apparatus in which the image pickup section is fixed while the reference light emitting section is moved;

FIG. 9 is a block diagram of the hologram reproduction apparatus;

FIGS. 10, 11, 12 and 13 are schematic views illustrating different reading operations by the reproduction apparatus;

FIG. 14A is a diagrammatic view illustrating a first example of a content data recording form according to the present invention;

FIG. 14B is a diagrammatic view illustrating a second example of a content data recording form according to the present invention;

FIG. 14C is a diagrammatic view illustrating a third example of a content data recording form according to the present invention;

FIG. 14D is a diagrammatic view illustrating a fourth example of a content data recording form according to the present invention;

FIG. 14E is a diagrammatic view illustrating a fifth example of a content data recording form according to the present invention;

FIG. 15 is a block diagram of a content data use management system to which the present invention;

FIG. 16A is a diagrammatic view illustrating an example of communication which is carried out using a telephone set which has a data communication function for communication with the content data use management system;

FIG. 16B is a similar view but illustrating another example of communication which is carried out using a network through a computer with the content data use management system;

FIG. 17A is a schematic view illustrating imaged audio data and images, which can be visually recognized by a person, recorded in a multiplexed fashion in a hologram memory by a different content providing medium production system to which the present invention is applied;

FIG. 17B is a schematic view illustrating recording of data by the different content providing medium production system;

FIG. 18 is a schematic view showing reproduced images of the hologram memory by the different content providing medium;

FIG. 19 is a block diagram of another production procedure according to the content providing medium production system;

FIGS. 20A, 20B, 20C and 20D are schematic views illustrating forms of a data block as a recording unit of content data used in the different content providing medium production system; and

FIG. 21 is a block diagram of another hologram master production apparatus to which the present invention is applied.

### DETAILED DESCRIPTION OF THE PREFERRED EMBODIMENTS

In the following, preferred embodiments of the present invention are described in the following order.

1. Configuration of the download system

2. Content providing medium production system

3. Configuration of the hologram reproduction apparatus (download apparatus)

4. Content data to be downloaded

5. Recording forms of content data

6. Use permission of a downloaded content

7. Mixed recording of content data and visual recognition image data

8. Modifications

1. Configuration of the Download System

The present invention can be applied to a download system wherein a user can download a music content for pay or free of charge. It is to be noted that the term “download” is used not in such a narrow sense that data is fetched into a terminal apparatus from a server through a network but in such a wide sense that a content provided is fetched into a terminal apparatus. In other words, the term “download” includes the significance of distribution.

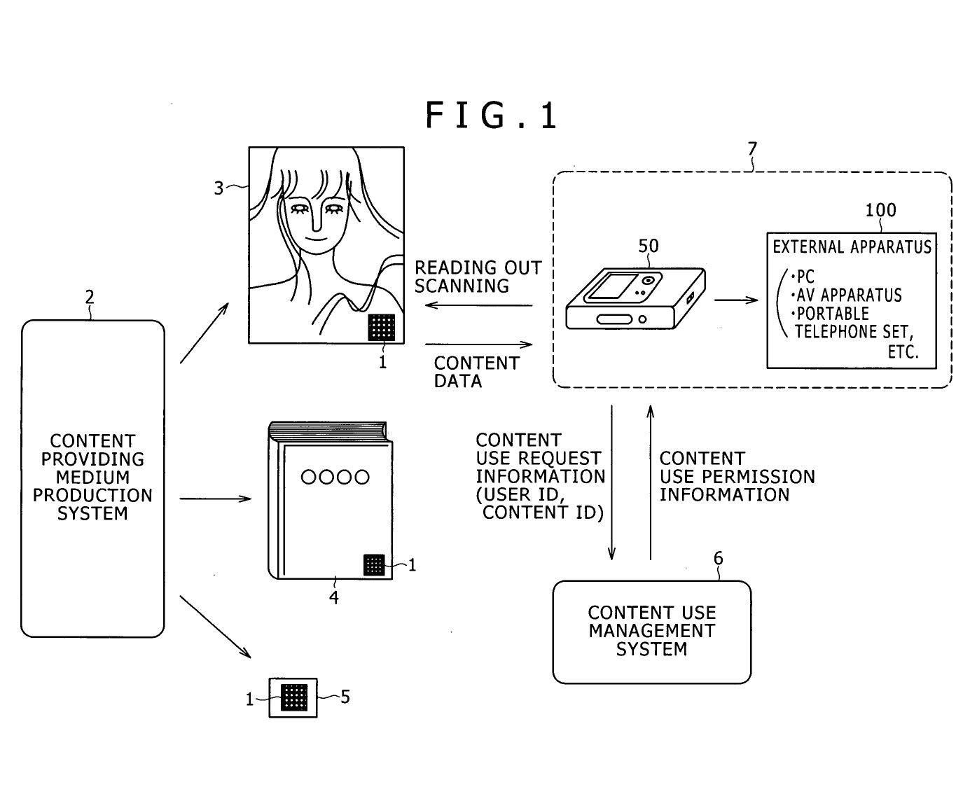

FIG. 1 shows an example of a configuration of the download system.

Referring to FIG. 1, a content providing medium production system 2 produces a content providing medium which includes a hologram memory 1. In particular, for example, a content hold such as a music label or music publication company, a memory maker, a mastering trader, a duplicating trader, a printing trader or the like takes part in production of content providing media by the content providing medium production system 2.

In FIG. 1, a poster 3, a book 4 and a package medium 5 are listed as examples of the content providing medium.

For example, the content providing medium production system 2 fabricates a poster 3 as a content providing medium wherein a hologram memory 1 in which a tune of an artist is recorded is formed by adhesion or printing on a poster of the artist.

Further, the content providing medium production system 2 produces a poster 3 which includes a hologram memory 1 on the front cover or the reverse cover or in pages or the like.

Further, the content providing medium production system 2 produces a package medium 5 which uses a hologram memory 1 as such a package medium such as a CD or a DVD.

Naturally, the articles mentioned are mere examples of the content providing medium, and the content providing medium to be produced by the content providing medium production system 2 may be various products which include a hologram memory 1 in which content data of a music content or the like is recorded.

In the download system of FIG. 1, a user apparatus 7 represents an apparatus which is used for downloading of content data or the like by a user.

It is required for the user side to prepare at least a hologram reproduction apparatus 50. The user would cause the hologram reproduction apparatus 50 to execute reading out scanning of a hologram memory 1 provided on a content providing medium to read out content data recorded in the hologram memory 1, that is, download the content data.

For example, when the user sees a poster 3 at a shop front or purchases a book 4, the user would oppose the hologram reproduction apparatus 50 to the hologram memory 1 at a portion of the hologram memory 1 and perform an operation to issue a downloading instruction so that the hologram reproduction apparatus 50 fetches a reproduction image from the hologram memory 1 and decode and acquire content data such as audio data from the reproduction image. The reading out scanning of the hologram memory 1 by the hologram reproduction apparatus 50 may be any of the contact type and the contactless type.

The hologram reproduction apparatus 50 may record the fetched content data into an internal secondary recording medium and then, for example, reproduce the content data so as to provide music or the like to the user. Alternatively, the hologram reproduction apparatus 50 may transfer the recorded content to an external apparatus 100 using a communication function so that the content data may be used on the external apparatus 100. The external apparatus 100 may be a personal computer, a portable telephone set, an AV (Audio-Visual) apparatus or the like which the user can use.

A content use management system 6 functions when some restriction should be applied to use of content data downloaded from the hologram memory 1 such as where content data should be downloaded for pay or where, although content data is charge-free, the content data should be provided only to a user who has the qualification of use.

For example, charged content data are recorded in an encrypted form or with a use restriction flag or the like added thereto in the hologram memory 1 such that, even if the hologram reproduction apparatus 50 downloads such content data, the hologram reproduction apparatus 50 cannot reproduce the content data as it is. In this instance, content use request information is transmitted from the hologram reproduction apparatus 50 side to the content use management system 6. The content use request information includes, for example, a content ID (identifier) applied to the content data, a user ID, an apparatus ID and so forth.

After the content use request information is received, the content use management system 6 performs a charging process, a use qualification discrimination process and so forth for the user and transmits, if use of the content may be permitted based on results of the discrimination, content use permission information to the user. The content use permission information includes, for example, a decryption key, information for invalidating the use restriction flag or the like so that the user who receives the content use permission information can use the content data fetched into the hologram reproduction apparatus 50 in an ordinary use manner. For example, the user can use the hologram reproduction apparatus 50 to reproduce and output the content data or transmit the content data to the external apparatus 100.

In this manner, in the content download system of FIG. 1, a poster 3, a book 4 or the like which is distributed generally is used as a content providing medium, and content data recorded in a hologram memory 1 on the content providing medium can be downloaded by the user using the hologram reproduction apparatus 50. Further, the system described may provide a charged download service.

Although a system wherein speech information or a part of tune is transmitted to a reproduction apparatus for exclusive use or a portable telephone set using a two-dimensional barcode such as the QR code is available already, the two-dimensional barcode is limited in the recording capacity to approximately several hundreds bytes and is insufficient as a medium for providing content data of music or the like to a user. It is impossible to use the two-dimensional barcode to construct a download system for content data equivalent in quality and amount to content data which is provided by a package medium such as a CD or a DVD or by an EMD.

In contrast, the hologram memory 1 can deal with a significantly greater amount of information and has a capacity sufficient to record a music content of high quality. It is not difficult to record an amount of data of, for example, several MB to several tens MB into the hologram memory 1, and it is estimated that also it is possible to record a data amount of, for example, approximately 1 GB into the hologram memory 1.

According to a compression technique for music data in recent years, sound quality of a level substantially equal to that of an MD (138 kbps by the ATRAC1 compression system) at a rate of approximately 64 kbps can be assured. Further, where the ATRAC3plus is supposed as the codec and the rate is 256 kbps, sound quality of a level substantially equal to that of a CD can be assured.

For example, if a music content for 5 minutes at the rate of 64 kbps is compressed, then the data capacity can be reduced to 2.4 MB. At the rate of 256 kbps, the data capacity can be increased to four times and 9.6 MB. Although such amounts of data can be transferred in a short period of time if high-speed data communication means according to the ADSL or an optical fiber system are used, according to communication by a telephone line or the like, several minutes are required inconveniently.

Meanwhile, since the hologram memory 1 can sufficiently record therein content data of such amounts as mentioned above, in the download system of the present embodiment, a music content or the like can be downloaded by the hologram reproduction apparatus 50 even if high-speed communication means is not used.

Further, in the present embodiment, if a less expensive hologram sheet is produced as the hologram memory 1 and inserted in a poster 3, a book 4 such as a magazine or the like by adhesion or the like, then the content itself can be distributed to a position which a user or users see frequently. In other words, if a user wants to acquire the content data when the user looks at the poster 3 or the like, then the user can acquire the content data immediately using the hologram reproduction apparatus 50 owned thereby without the necessity for complicated system environments and without complicated labor or time.

The downloaded content data itself can be reproduced by the hologram reproduction apparatus 50 at the site or transferred to an external apparatus 100 on which the user can use the content data.

In short, according to the download system of the present embodiment, the provider side of content data can duplicate and insert an inexpensive hologram memory 1 into a content providing medium such as a poster 3 to distribute the content data by a large amount so as to increase the opportunity in which a user looks at the content data and increase the purchase of the content.

Also the user side can simply download the content by scanning the hologram memory 1 in the form of a sheet adhered to a magazine, a poster or the like using the hologram reproduction apparatus 50 and can use the content by reproduction and so forth.

The hologram memory 1 is suitable also for advertisement applications. For example, although a conventional advertisement cannot convey a great mount of information from a restriction of the space, if data of explanation of a commodity, images, sound and forth are recorded as content data in the hologram memory 1, then a very great amount of information can be conveyed to users.

2. Content Providing Medium Production System

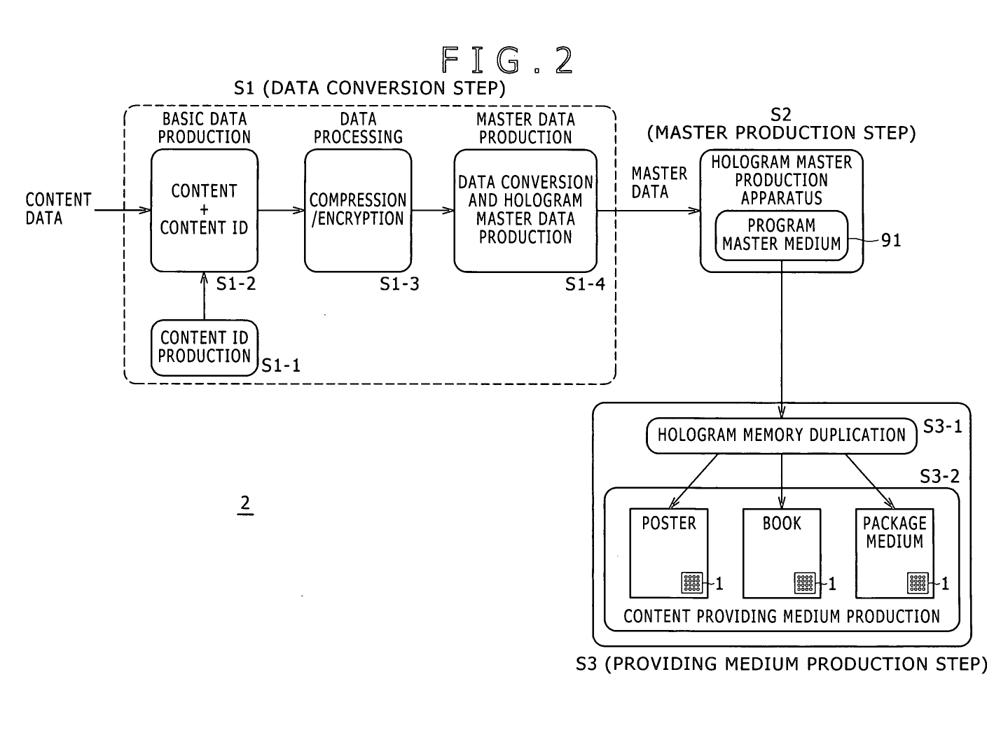

A production method of a content providing medium by the content providing medium production system 2 shown in FIG. 1 and a content providing medium produced by the production method are described with reference to FIGS. 2 to 7B.

A process of producing a content providing medium which includes a hologram memory 1 in which content data is recorded can be roughly divided into a data conversion step S1, a master production step S2 and a providing medium production step S3 illustrated in FIG. 2.

At the data conversion step S1, audio data or the like as content data is converted into master data to be recorded into a hologram memory 1.

At the master production step S2, a hologram master medium 91 in which the master data is recorded is produced.

At the providing medium production step S3, a hologram memory 1 in the form of a sheet is duplicated from the hologram master medium 91. Then, the hologram memory 1 in the form of a sheet is adhered to a book 4, a poster 3 or the like to form a content providing medium. It is to be noted that the hologram memory 1 may not be adhered, but may be formed directly on a book or the like by printing as another technique.

The data conversion step S1 is divided into a content ID production step S1-1, a basic data production step S1-2, a data processing step S1-3 and a master data production step S1-4.

A content data holder who owns content data, for example, a label or record company in the case of a music content or the like provides the content data to a master producer and requests the master producer to produce a hologram master medium 91. In accordance with the request, the master producer performs a process of the data conversion step S1.

First, at the content ID production step S1-1, a content ID is produced for each of individual content data provided.

Then, at the basic data production step S1-2, the content IDs are added to the provided content data to produce basic data.

The content ID to be added to each content data may be such an ID with which an apparatus which reproduces the content when information is hacked can be revoked.

Then at the data processing step S1-3, a necessary data process is performed for the content data. For example, for audio content data, a compression process according to the ATRAC system or the MPEG audio system is performed.

Further, an encryption process may be performed in order to restrict reproduction after downloading for the object of charging or specification of a user.

Then, for a data string obtained by the data processing step S1-3, conversion necessary for recording as holograms is performed at the master data production step S1-4. For example, the data string is developed into two-dimensional data.

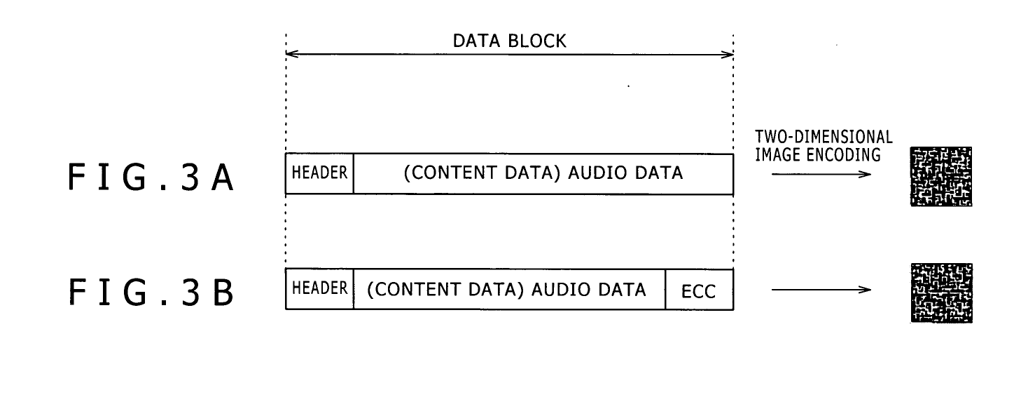

Examples of the process at the step data conversion step S1 are schematically illustrated in FIGS. 3A and 3B.

A data block in FIGS. 3A and 3B represents a recording unit formed by extracting audio data as stream data for every predetermined size.

In the example of FIG. 3A, a header is added to audio data of a predetermined data amount to produce a data block and the produced data block is used as a recording unit. The recording unit is an example of a unit recorded as a hologram element in a hologram material by a hologram master production apparatus hereinafter described.

The header has a content ID recorded therein. The header further has an attribute, a block number, a data size and so forth of the audio data recorded therein.

The audio data is in a form compressed by a predetermined compression method or encrypted by a predetermined encryption method.

In the example of FIG. 3B, an error correction code (ECC) is added to the header and audio data described above to form a data block. In particular, the audio data in the data block is encoded for error correction and an ECC parity is recorded into the audio data so that, upon reproduction, an error correction process can be performed in a unit of a data block.

After such a data block as described above is produced at the basic data production step S1-2 and the data processing step S1-3, at the master data production step S1-4, two-dimensional image encoding is performed to convert the data blocks into data of two-dimensional image patterns.

Thereafter, at the step S2, the master producer uses a hologram master production apparatus to produce a hologram master medium 91 on which the master data produced at the data conversion step S1 are recorded. Although an example of the hologram master production apparatus is hereinafter described, a master can be produced by causing master data, for example, in the form of a two-dimensional data string to be displayed on a display screen such as a liquid crystal display panel and then printing the display image on a hologram material such as photopolymer using object light representing the display image and reference light.

It is to be noted that holograms may be formed not from a material such as photopolymer but by providing irregularities on aluminum, and the production technique for the hologram master medium 91 differs depending upon what type of a hologram master medium 91 should be produced.

The hologram master medium 91 produced by the master production step S2 is passed to the providing medium production step S3. The providing medium production step S3 is divided into, for example, a hologram memory duplication step S3-1 and a content providing medium production step S3-2.

The hologram master medium 91 is passed, for example, to a duplication trader. Then, the duplication trader uses the hologram master medium 91 to produce hologram memories 1 in the form of a sheet in a mass at the hologram memory duplication step S3-1.

The duplication method may be, for example, a close contact copying method of contacting the hologram master medium 91 closely with a photosensitive material to transfer information.

Also an emboss hologram method may be used wherein a concave-convex image formed from holograms recorded on photoresist is electrically deposited to produce a stamper and hologram master media are duplicated using the stamper.

The hologram memories 1 produced in a mass are distributed, for example, to manufacturers of books, posters, package media and so forth and are adhered to the books and so forth at the providing medium production step S3-2 thereby to complete content providing media.

It is to be noted that the hologram memory duplication step S3-1 and the content providing medium production step S3-2 are sometimes executed integrally. This is a case, for example, wherein a hologram memory 1 is formed on a product as a content providing medium by direct duplication printing or the like.

The produced content providing media are distributed to shops, various equipments and so forth and placed into a state wherein they are watched by general users. In other words, the content providing media are placed into a downloadable state.

It is to be noted that, in the procedure described above, encryption of content data and setting of a content ID are executed at the data conversion step S1. For example, although the operations at the master production step S2 and the providing medium production step S3 may possibly be entrusted to an external trader by the master producer, where encryption and so forth are executed at the data conversion step S1, outflow of content information can be prevented.

Now, an example of a hologram master medium 91 produced at the master production step S2 and a hologram memory 1 duplicated from the hologram master medium 91 is described.

It is to be noted that, while various types are available for a hologram recording medium in which data is recorded in the form of interference fringes formed with object light and reference light, in the example described below, the hologram master medium 91 is produced as a hologram recording medium of the holographic stereograph type.

In a conventionally known hologram recording medium of the holographic stereogram type, recording is performed such that a large number of images are used as the original pictures and successively recorded as rectangular or dot-shaped elementary holograms in the single hologram recording medium.

In the holographic stereogram, since information of a plurality of images obtained by successively picking up images of a subject from observation points different from each other in a transverse direction is successively recorded such that it continues in the transverse direction as rectangular elementary holograms, when an observing person watches the holographic stereogram with both eyes, two-dimensional images which look to the left and right eyes are a little different from each other. Consequently, the observing person feels a parallax, and a three-dimensional image is reproduced. In other words, an image which can be visually recognized, for example, three-dimensionally is recorded as interference fringes of object light and reference light.

Also it is known that such a hologram recording medium as described above can enhance the recording density significantly and achieve a very great storage capacity. Therefore, it is considered that the hologram recording medium is useful not only for reproduction of a three-dimensional image but also as a recording medium for recording various data such as computer data.

For example, where the graphic stereogram system described above is applied, computer data such as audio data, video data, text data and program data are converted into two-dimensional images for individual predetermined recording units. For example, such an image pattern as a two-dimensional barcode (QR code) is produced. Then, a large number of image patterns are produced as two-dimensional images for individual recording units and are individually recorded as rectangular elementary holograms successively. Such recording as just described makes it possible to significantly enhance the recording density when compared with that of the conventional two-dimensional barcodes by printing.

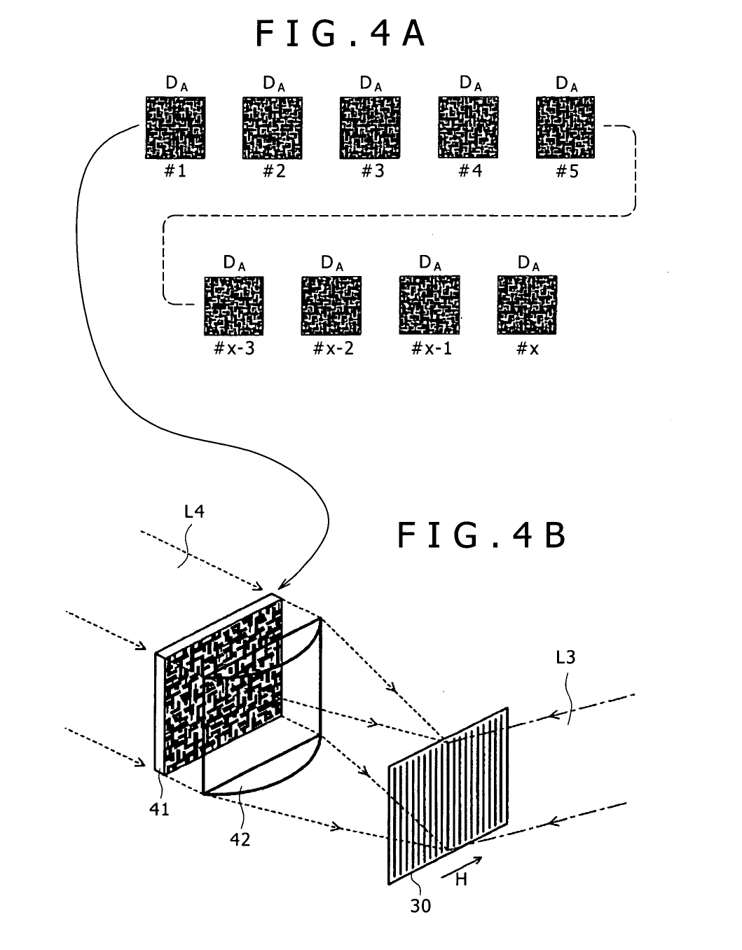

FIGS. 4A and 4B schematically illustrate that, for example, audio data are recorded on a hologram recording medium.

FIG. 4B illustrates a manner in which hologram elements are recorded in zones on a hologram material 30. Object light L4 and reference light L3 for recording are illuminated on the hologram material 30.

The object light L4 is illuminated on a display apparatus 41 of the transmission type, which may be formed, for example, from a liquid crystal panel while an image is displayed on the display apparatus 41. The object light L4 having transmitted through the display apparatus 41 makes object light which reflects the image displayed on the display apparatus 41, and this object light L4 is converted into a line extending in a vertical direction by a cylindrical lens 42 and then illuminated on the hologram material 30.

Interference fringes which appear when the object light L4 converted into a line in this manner and the reference light L3 interfere with each other are recorded as a zone-like hologram element extending in a vertical direction as seen in FIG. 4B on the hologram material 30.

In order to successively produce such zone-like hologram elements, the hologram material 30 is fed step by step, for example, in the direction indicated by an arrow mark H and the image to be displayed on the display apparatus 41 is successively changed. Consequently, zone-like hologram elements as interference fringes are formed in a lattice-like fashion on the hologram material 30.

At this time, if images of a certain object picked up from various angles are successively displayed on the display apparatus 41 so as to be recorded individually as hologram elements, then the recorded hologram elements look as a three-dimensional image when they are visually recognized. In the present example, the images to be displayed on the display apparatus 41 include patterns by which audio data are represented like a two-dimensional barcode. In other words, audio data are converted into pattern images like a two-dimensional barcode, and such pattern images are determined as hologram elements to be recorded.

FIG. 4A illustrates an example of images to be successively displayed on the display apparatus 41. The display apparatus 41 successively displays images based on audio data DA.

Each image based on the audio data DA is an image like a two-dimensional barcode as seen in FIG. 4A. Original audio data to be recorded are divided into recording units, for example, of a data size of a fixed length, and the audio data of each recording unit is converted into a two-dimensional barcode image pattern.

Where an image pattern in the form of a two-dimensional barcode is displayed on the display apparatus 41, the object light L4 which reflects the image pattern is illuminated on the hologram material 30, in which a linear hologram element on which the image pattern is recorded in the form of interference fringes between the object light L4 and the reference light L3 is formed. In other words, one recording unit of the audio data DA is recorded on the hologram material 30.

Thus, if images (#1 to #x) based on the audio data DA are successively displayed on the display apparatus 41 to successively form hologram elements on the hologram material 30 as seen in FIG. 4A, then a hologram recording medium in which the audio data DA are recorded can be formed.

In the present embodiment, the hologram material 30 in which holograms are recorded in such a manner as described above is used as a hologram master medium 91. Then, hologram memories 1 are duplicated from the hologram master medium 91.

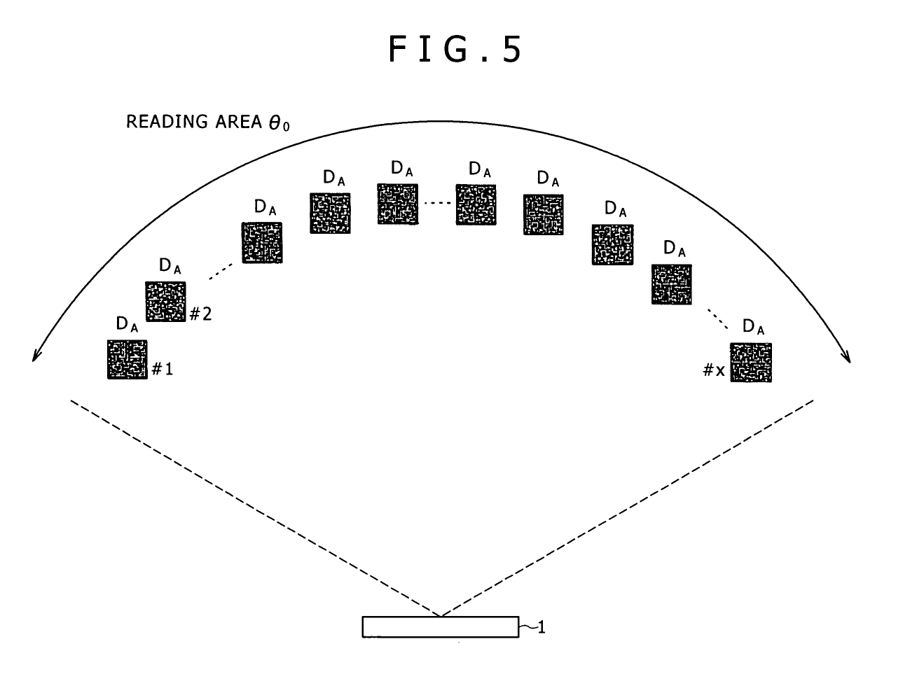

FIG. 5 illustrates a manner of a hologram memory 1 formed by duplication from the hologram master medium 91 produced in such a manner as described above.

Data recorded as hologram elements appear as an image which can be visually recognized by a person on the hologram memory 1. In this instance, to the hologram memory 1, external light such as light from a light source disposed in a certain direction or natural light from therearound serves as reference light.

Where the audio data DA are recorded in the order of #1 to #x as seen in FIG. 4A, image patterns of the audio data DA #1 to #x can be visually recognized from different angles with respect to the hologram memory 1, for example, as seen in FIG. 5.

Although any image pattern derived from the audio data DA is not an image whose substance in significance can be recognized by a person like a two-dimensional barcode, the image patterns derived from the audio data DA are read and processed by a hologram reproduction apparatus 50. The hologram reproduction apparatus 50 successively reads the images within a reading range θ0 shown in FIG. 5 by means of an image sensor. Namely, the hologram reproduction apparatus 50 reads each image pattern of the audio data DA #1 to #x. For example, the position of a lens system of the reproduction apparatus is successively moved or the position of reference light for reading out is successively moved while the optical images are successively read by means of the image sensor. Then, the image patterns are decoded into data of recording units. Then, stream data as the audio data DA are produced from the data of the recording units.

A hologram master production apparatus for producing a hologram master medium 91 from which a plurality of such hologram memories 1 as described above are to be formed for duplication, that is, a holographic stereogram production system, is described.

The hologram stereogram production system is a system for producing a one-step holographic stereogram, which uses a hologram material 30 in the form of a film on which interference fringes between object light and reference light are recorded as they are as a holographic stereogram (hologram master medium 91).

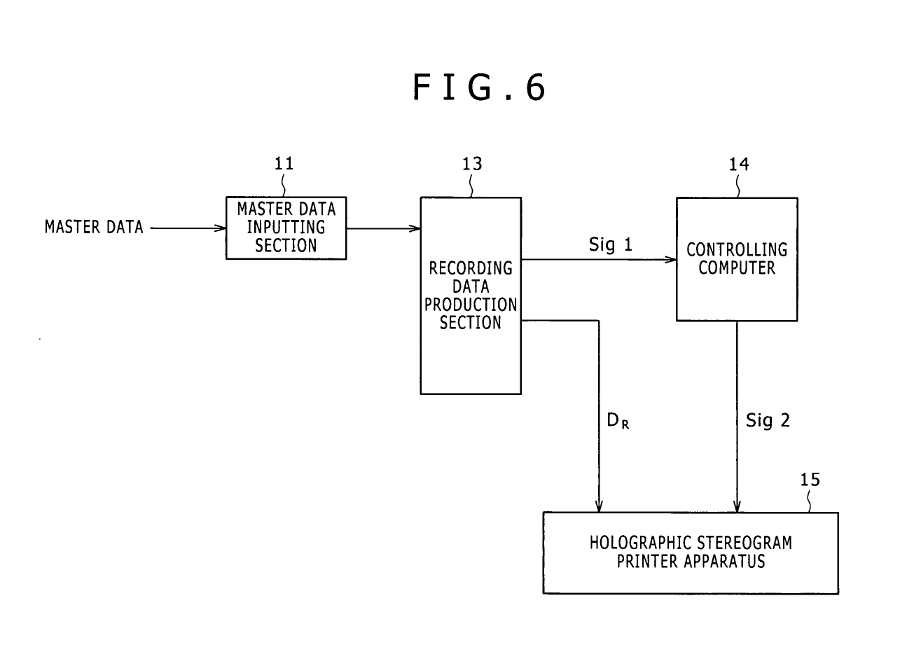

Referring to FIG. 6, the holographic master production apparatus includes a master data inputting section 11 for inputting master data produced at the data conversion step S1 of FIG. 2, and a recording data production section 13 for successively outputting image patterns of the audio data DA as master data as recording data DR. The holographic master production system further includes a controlling computer 14 for controlling the entire system, and a holographic stereogram printer apparatus 15 including an optical system for producing a holographic stereogram.

The master data inputting section 11 receives two-dimensional data produced from audio content data at the data conversion step S1 as an input thereto and passes the two-dimensional data to the recording data reproduction section 13. In particular, the master data inputting section 11 passes the image pattern data of #1 to #x illustrated in FIG. 4.

The recording data production section 13 fetches image patterns derived from the audio data DA from the master data input 11 and outputs the image patterns as recording data DR at predetermined timings in the order of #1 to #x.

In particular, upon recording on the hologram material 30, the recording data production section 13 successively signals the recording data DR in the order of #1 to #x to the holographic stereogram printer apparatus 15 and signals, every time the recording data DR are signaled to the holographic stereogram printer apparatus 15, a timing signal Sig 1 representing such signaling of the data to the controlling computer 14. The recording data DR are data of an image pattern based on the audio data DA.

The controlling computer 14 drives the holographic stereogram printer apparatus 15 based on the timing signal Sig 1 from the recording data production section 13 to successively record images based on the recording data DR outputted from the recording data production section 13 as rectangular elementary holograms on the hologram material 30 set in position in the holographic stereogram printer apparatus 15.

At this time, the controlling computer 14 controls a shutter mechanism, a recording medium feeding mechanism and other pertaining mechanisms provided in the holographic stereogram printer apparatus 15 as hereinafter described. In particular, the controlling computer 14 signals a control signal Sig 2 to the holographic stereogram printer apparatus 15 to control opening/closing of the shutter, a feeding movement of the hologram material 30 by the recording medium feeding mechanism and so forth.

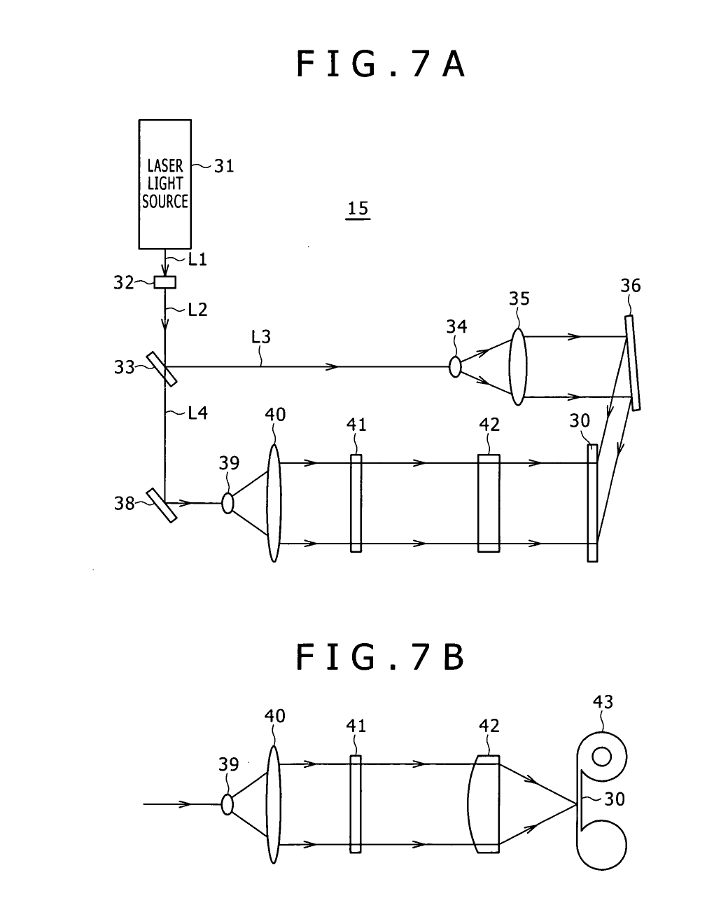

The holographic stereogram printer apparatus 15 includes an optical system, for example, shown in FIGS. 7A and 7B. It is to be noted that FIG. 7A shows the optical system of the entire holographic stereogram printer apparatus 15 as viewed from above, and FIG. 7B shows a portion of the optical system of the holographic stereogram printer apparatus 15 for object light as viewed from sidewardly.

Referring first to FIG. 7A, the holographic stereogram printer apparatus 15 includes a laser light source 31 for emitting a laser beam of a predetermined wavelength, and a shutter 32 and a half mirror 33 disposed on an optical axis of a laser beam L1 from the laser light source 31. The shutter 32 is controlled by the controlling computer 14 such that it is closed when the hologram material 30 is not to be exposed but is open when the hologram material 30 is to be exposed. The half mirror 33 is provided to split a laser beam L2 having transmitted through the shutter 32 into reference light and object light. The light L3 reflected by the half mirror 33 is used as the reference light, and the light L4 having transmitted through the half mirror 33 is used as the object light.

An optical system for the reference light is disposed on the optical axis of the reference light L3 reflected by the half mirror 33. The optical system for the reference light includes a cylindrical lens 34, a collimator lens 35 for converting the reference light into parallel light, and a total reflection mirror 36 for reflecting the parallel light from the collimator lens 35, disposed in order.

The light reflected by the half mirror 33 is first converted into divergent light by the cylindrical lens 34. Then, the divergent light is converted into parallel light by the collimator lens 35. Thereafter, the parallel light is reflected by the total reflection mirror 36 and enters as reference light into the hologram material 30.

Meanwhile, an optical system for the object light is disposed on the optical axis of the object light L4 having transmitted through the half mirror 33. Referring to FIGS. 7A and 7B, the optical system for the object light includes a total reflection mirror 38 for reflecting the transmitted light from the half mirror 33, a spatial filter 39 formed from a combination of a convex lens and a pinhole, a collimator lens 40 for converting the object light into parallel light, a display apparatus 41 for displaying an image of an object of recording, and a cylindrical lens 42 for focusing the object light on the hologram recording medium 30, disposed in order.

The object light L4 having transmitted through the half mirror 33 is first reflected by the total reflection mirror 38 and then converted into divergent light from a point light source by the spatial filter 39. Then, the divergent light is converted into parallel light by the collimator lens 40 and the comes to the display apparatus 41. The display apparatus 41 is an image display apparatus of the transmission type formed from, for example, a liquid crystal panel and displays an image based on recording data DR sent thereto from the recording data production section 13. Then, the light having transmitted through the display apparatus 41 is modulated in accordance with the image displayed on the display apparatus 41 and comes to the cylindrical lens 42.

The light having transmitted through the display apparatus 41 is converged in a transverse direction by the cylindrical lens 42, and the converged light enters as object light into the hologram recording medium 30. In short, in the present holographic stereogram printer apparatus 15, projection light from the display apparatus 41 enters as rectangular object light into the hologram recording medium 30.

Here, the reference light and the object light are set such that the reference light enters one of principal faces of the hologram material 30 while the object light enters the other principal face of the hologram material 30. In other words, the reference light is introduced at a predetermined incident angle to one principal face of the hologram material 30 while the object light is introduced to the other principal face of the hologram material 30 such that the axis thereof may be substantially perpendicular to the hologram material 30. Consequently, the reference light and the object light interfere with each other on the hologram material 30, and interference fringes produced by the interference are recorded as variations in refractive index in the hologram material 30.

The holographic stereogram printer apparatus 15 further includes a recording medium feeding mechanism 43 capable of intermittently feeding the hologram material 30 under the control of the controlling computer 14. The recording medium feeding mechanism 43 intermittently feeds the hologram material 30, which is in the form of a film and set in a predetermined condition on the recording medium feeding mechanism 43, by a distance corresponding to the size of one elementary hologram in accordance with the control signal S2 from the controlling computer 14 every time one image based on recording data DR outputted from the recording data production section 13 is recorded as one elementary hologram. As a result, images based on the recording data DR successively outputted from the recording data production section 13 (that is, image patterns #1 to #x based on the audio data DA) are successively recorded as elementary holograms such that they continue in the transverse direction on the hologram material 30.

As described above, in the present hologram master production system, a plurality of exposure images based on recording data DR outputted from the recording data production section 13 are successively displayed on the display apparatus 41, and the shutter 32 is opened for every image such that the images are successively recorded as rectangular elementary holograms on the hologram material 30. At this time, since the hologram material 30 is fed by a one-elementary hologram distance for every one image, the elementary holograms are juxtaposed with each other in the transverse direction. Consequently, as the image data DP, for example, image patterns derived from audio data DA are recorded as a plurality of transversely continuing elementary holograms.

Then, the hologram material 30 on which the recording data DR are recorded by the present system makes the hologram master medium 91 described hereinabove with reference to FIG. 2.

A hologram memory 1 duplicated using the hologram master medium 91 is used as the hologram memory 1 described hereinabove with reference to FIG. 5 and is adhered, for example, to a poster, a book or the like.

3. Configuration of the Hologram Reproduction Apparatus (Download Apparatus)

Now, a hologram reproduction apparatus 50 for the hologram memory 1 in which content data of audio data DA and so forth are recorded in the form of a two-dimensional pattern image as seen in FIG. 2 is described. In particular, the hologram reproduction apparatus 50 is a download apparatus for downloading content data from a hologram memory 1 adhered to a poster, a book or the like.

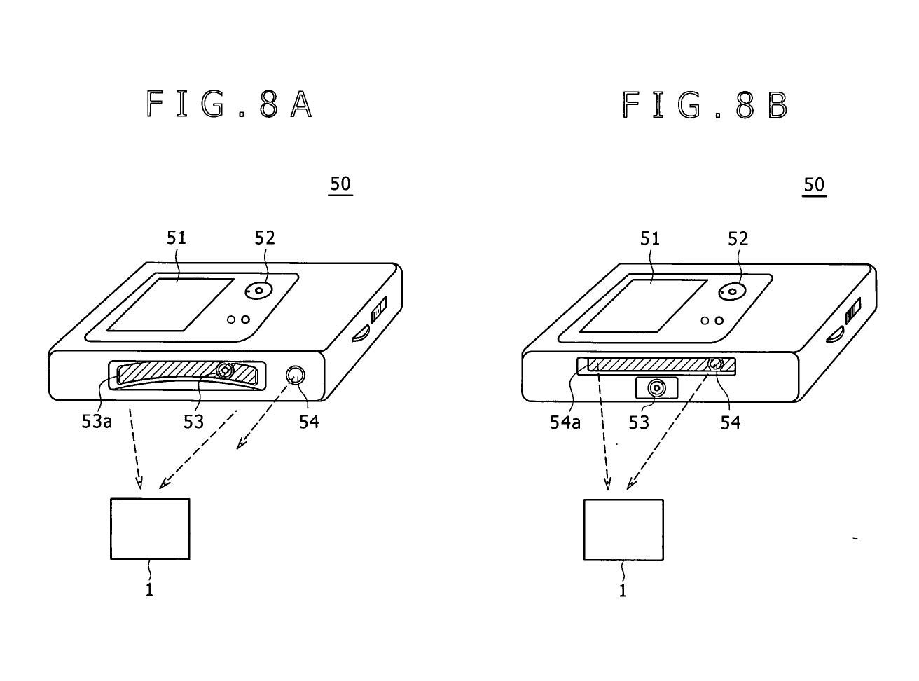

FIGS. 8A and 8B show different examples of the appearance of the hologram reproduction apparatus 50.

Referring to FIGS. 8A and 8B, the hologram reproduction apparatus 50 includes a housing, for example, of such a small size that it can be carried by the user, and further includes a display section 51 and an operation section 52 for the user interface on the housing.

In order to read out data from the hologram memory 1, an image pickup lens system 53 and a light emitting element (LED) 54 for irradiating reference light for reading are provided, for example, on one side face of the housing.

As described hereinabove with reference to FIG. 2, the hologram reproduction apparatus 50 performs reading scanning of the hologram memory 1 within the reading range θ0. To this end, in the case of the hologram reproduction apparatus 50 shown in FIG. 8A, the position of the light emitting element 54 is fixed while a mechanism for moving the position of the image pickup lens system 53 is provided as a lens moving section 53a. On the other hand, in the case of the hologram reproduction apparatus 50 shown in FIG. 8B, the image pickup lens system 53 is fixed while a light emitting element moving section 54a for moving the position of the light emitting element 54 is provided.

An example of a scanning operation upon reading is hereinafter described.

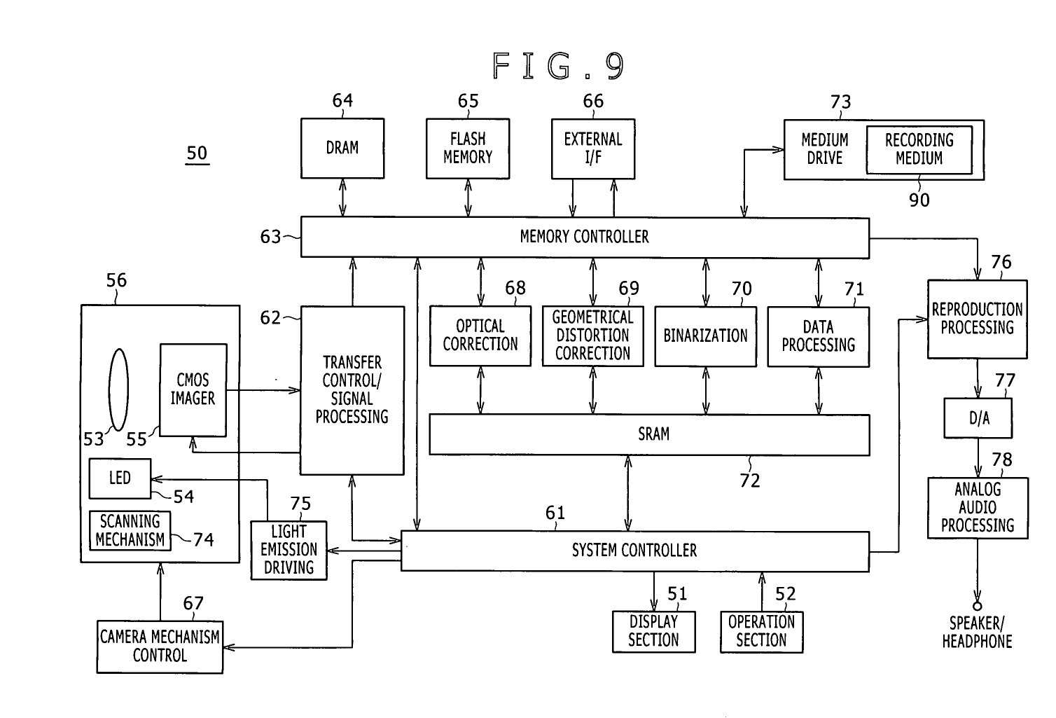

A configuration of the hologram reproduction apparatus 50 is described with reference to FIG. 9.

The hologram reproduction apparatus 50 includes a system controller 61 which is formed from, for example, a microcomputer and controls components of the hologram reproduction apparatus 50 in order to execute a reading operation of audio data DA from the hologram memory 1.

Further, the system controller 61 supervises operation information of the operation section 52 and executes necessary control in response to an operation of the operation section 52 by the user. Further, the system controller 61 controls the display section 51 to execute displaying of various kinds of information to be presented to the user.

A reading mechanism section 56 includes the image pickup lens system 53, an imager 55, the light emitting element 54, and a scanning mechanism 74. The image pickup lens system 53 is an optical system composed of one or a plurality of lenses. In particular, the image pickup lens system 53 is composed of a single image pickup lens or a plurality of lenses including an image pickup lens and a focusing lens and introduces reproduction image light from the hologram memory 1 to the imager 55. The imager 55 is formed from a solid-state image pickup element array such as, for example, a CMOS image sensor or a CCD image sensor. The imager 55 receives light of a reproduction image incoming from the image pickup lens system 53 and coverts the received light into an electric signal.

The light emitting element 54 is formed from, for example, an LED and driven by a light emission driving circuit 75 to emit light. The light emitting element 54 is driven to emit light in response to an instruction of the system controller 61 when reproduction of the hologram memory 1 is to be performed by the hologram reproduction apparatus 50.

The scanning mechanism 74 moves the lens system 53 (lens system 53 and imager 55) within the lens moving section 53a provided, for example, in such a manner as seen in FIG. 8A. Or, the scanning mechanism 74 moves the light emitting element 54 within the light emitting element moving section 54a provided, for example, in such a manner as seen in FIG. 8B.

A camera mechanism control section 67 controls and drives the reading mechanism section 56 in accordance with an instruction of the system controller 61 when the hologram memory 1 is to be reproduced. For example, the camera mechanism control section 67 performs focusing control of the lens system 53 or control of operation of the scanning mechanism 74.

A transfer control/signal processing section 62 controls operation of the imager 55 and processes a signal obtained by the imager 55.

In particular, the transfer control/signal processing section 62 supplies a transfer timing signal, a transfer address signal and so forth to the imager 55 to cause the imager 55 to successively transfer and output a signal obtained as an image pickup signal from the solid-state image pickup element array. Then, the image pickup signal transferred from the imager 55 is outputted as image pickup data after a sampling process, an AGC process, an A/D conversion process and other necessary processes are applied thereto by the transfer control/signal processing section 62.

The image pickup data outputted from the transfer control/signal processing section 62 is accumulated into a DRAM 64 under the control of a memory controller 63.

As a signal processing system for the image pickup data accumulated in the DRAM 64, an optical correction section 68, a geometrical distortion correction section 69, a binarization section 70 and a data processing section 71 are provided. Further, an SRAM 72 is used for communication of results of processes by the pertaining components and information necessary for processing with the system controller 61.

Further, for example, set values and coefficients necessary for the signal processing by the pertaining components and other necessary information are stored into a flash memory 65. Further, use permission information, a decryption key and so forth hereinafter described are recorded into the flash memory 65.

The optical correction section 68 performs a process of correcting a variation of a data value brought about by an optical cause with regard to image data obtained by the imager 55.

The geometrical distortion correction section 69 performs a process of correcting geometrical distortion appearing on a reproduction image fetched as image pickup data.

The binarization section 70 performs a process of converting image pickup data obtained by the imager 55 and having gradations into data of binary values of black and white. This is because data to be read from the hologram memory 1 are audio data DA of two-dimensional patterns and two-dimensional image patterns are obtained by first converting audio data DA into two-value data of black and white and then converting the two-value data into image patterns.

The data processing section 71 performs a decoding process for image pickup data binarized into a two-dimensional image pattern to obtain audio data.

In particular, the data processing section 71 produces a data string as such a data block as described hereinabove with reference to any of FIGS. 3A and 3B from image data as a two-dimensional image pattern.

The data processing section 71 successively produces a data string as a data block from image pickup data of two-dimensional image patterns accumulated in the DRAM 64 and successively produces original audio stream data based on the audio data DA extracted from the data blocks.

In this instance, if a data block includes an error correction code as described hereinabove with reference to FIG. 3B, then the data processing section 71 performs an error correction process for the audio data.

Further, the data processing section 71 performs, for audio data DA extracted from any data block, a compression process or a decompression process corresponding to the compression process, an encoding or encrypting process for transmission or recording, a decoding or decrypting process corresponding to the encoding or encrypting process, and other necessary processes as occasion demands.

Audio stream data as audio data DA obtained by the data processing section 71 are transferred as reproduction data from the hologram memory 1 to an external apparatus 100 such as, for example, a personal computer or an audio system through an external interface 66. The external interface 66 may be, for example, a USB interface. Naturally, the external interface 66 may otherwise be an interface according to a standard other than the USB standard.

The user can cause the external apparatus 100 to reproduce the fetched audio data to enjoy audio reproduction.

Alternatively, audio stream data as audio data DA obtained by the data processing section 71 may be supplied to a medium drive 73 and recorded on a secondary side recording medium 90. Also such information as a content ID included in the header is recorded on the secondary recording medium 90 together with the audio data DA.

The secondary side recording medium 90 may be, for example, an optical disk, a magneto-optical disk or the like. For example, various recordable disks such as, for example, a CD (Compact Disc), a DVD (Digital Versatile Disc), a Blu-Ray disk or an MD (Mini Disc) may be used as the secondary side recording medium 90. Where any of the disks mentioned is applied as the secondary side recording medium 90, the medium drive 73 performs an encoding process and an error correction coding process and further performs, if necessary, a compression process and so forth suitable for the disk type for audio data and records the resulting audio data on the disk.

Also a hard disk may be applied as the secondary side recording medium 90. In this instance, the medium drive 73 is formed as a hard disk drive (HDD).

Or else, the secondary side recording medium 90 may be implemented using a portable memory card having a solid-state memory built therein or a built-in type solid-state memory. In this instance, the medium drive 73 is formed as a recording apparatus section for such a memory card or a built-in type solid-state memory as just mentioned, and performs a necessary signal process for audio data and records the resulting audio data. For the built-in type solid-state memory, not only a nonvolatile memory such as a flash memory but also a volatile memory such as a DRAM may be used.

The audio data DA recorded on the secondary recording medium 90, that is, the content data downloaded from the hologram memory 1, can be read out from the secondary recording medium 90 by the medium drive 90 and transmitted to the external apparatus 100 by the external interface 66.

Furthermore, where the audio data DA are recorded on a recording medium 90 of the portable type such as a CD, a DVD, a Blur-ray disk, an MD or a memory card as mentioned hereinabove, the user can cause the recording medium 90 to be reproduced on the external apparatus to enjoy music or the like read out from the hologram memory 1.

Further, the hologram reproduction apparatus 50 includes a reproduction processing section 76, a D/A converter 77 and an analog audio processing section 78 in order that the hologram reproduction apparatus 50 itself can reproduce and output content data.

The reproduction processing section 76 decodes, when audio data recorded on the recording medium 90 is read out by the medium drive 73, the read out audio data. For example, the reproduction processing section 76 performs decompression of audio data of the recording medium 90 or performs, where audio data are recorded in an encrypted form on the recording medium 90, a decryption process for the audio data.

For example, audio data decoded into a state of linear PCM audio data by the reproduction processing section 76 is converted into an analog sound signal by the D/A converter 77 and then undergoes such processes as amplification, gain adjustment and impedance adjustment by the analog audio processing section 78. Then, the resulting analog sound signal is supplied to a speaker section or a headphone section connected to the hologram reproduction apparatus 50 so that it is outputted as reproduced sound from the speaker section or headphone.

Consequently, the user can use the hologram reproduction apparatus 50 to reproduce the downloaded audio content to enjoy music or the like.

It is to be noted that the components of the hologram reproduction apparatus 50 shown in FIG. 9 and the features of the claims of the present application have the following corresponding relationship:

The light emitting element 54 and light emission driving circuit 75 function as a reference light outputting section.

The reading mechanism section 56 and transfer control/signal processing section 62 function as a detection section.

The data processing section 71 functions as a reproduction processing section.

The medium drive 73 functions as a recording section for a secondary recording medium.

The medium drive 73, reproduction processing section 76, D/A converter 77 and analog audio processing section 78 function as a reproduction outputting section for reproducing and outputting content data.

The external interface 66 function as a transmission section for transmitting computer data to an external apparatus.

The data processing section 71 or reproduction processing section 76 functions as a decryption section.

An example of operation of reading data from the hologram memory 1 using the hologram reproduction apparatus 50 having such a configuration as described above with reference to FIG. 8A or 8B and 9 is described.

Although the method wherein various images are recorded using an HPO (Horizontal Parallax Only) type optical system with the angle of reference light fixed is described with reference to FIGS. 6, 7A and 7B, where such recording is performed, it is basically preferable to vary, upon reproduction, the angle of the imager while the angle of the reference light is fixed.

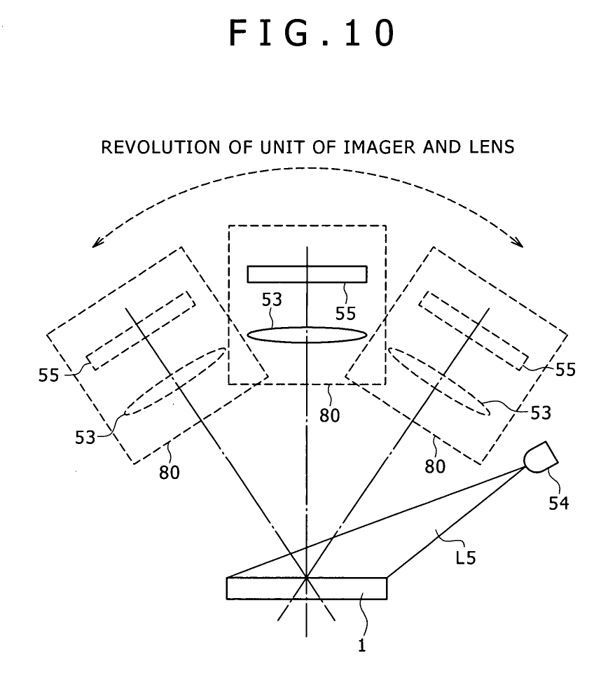

FIG. 10 illustrates a reading method of the hologram reproduction apparatus 50 wherein the angles of the image pickup lens system 53 and the imager 55 are varied. In particular, in the hologram reproduction apparatus 50 having the lens moving section 53a as described hereinabove with reference to FIG. 8A, a movement unit 80 for moving the lens system 53 and the imager 55 integrally with each other within a movable range of the lens moving section 53a is formed. Then, the movement unit 80 is moved in the direction of revolution as seen in FIG. 10 by the scanning mechanism 74 shown in FIG. 9 to vary the angle of the image pickup direction with respect to the hologram memory 1. The light emitting element 54 for outputting reference light L5 for the reading remains at the fixed position.

In particular, if the user performs an operation to issue an instruction to read the hologram memory 1 in a state wherein the hologram reproduction apparatus 50 is opposed to the hologram memory 1, then the system controller 61 issues an instruction to the camera mechanism control section 67 to drive the scanning mechanism 74 to revolutionarily move the movement unit 80. At this time, the image pickup data of #1 to #x of FIG. 5 are obtained as image pickup data of reproduction images successively obtained by the imager 55, and audio data DA are obtained in the hologram reproduction apparatus 50 in such a manner as described above.

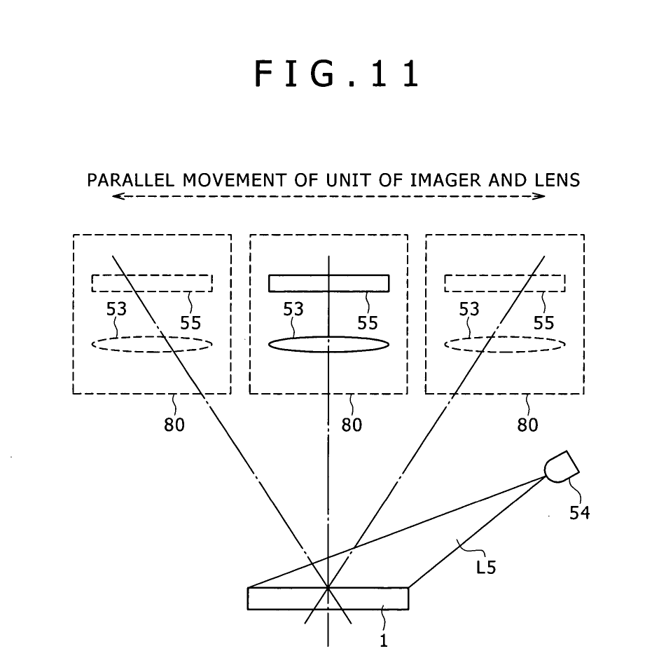

However, the movement unit 80 may not be moved in a revolutionary direction but may be moved parallelly as seen in FIG. 11.

Where reproduction images are fetched through such parallel movement of the movement unit 80 in this manner, the mechanism for moving the movement unit 80 can be formed in a simple configuration. However, this configuration is disadvantageous in that a reproduction image is likely to be distorted, and a sufficient distortion correction process or the like is required.

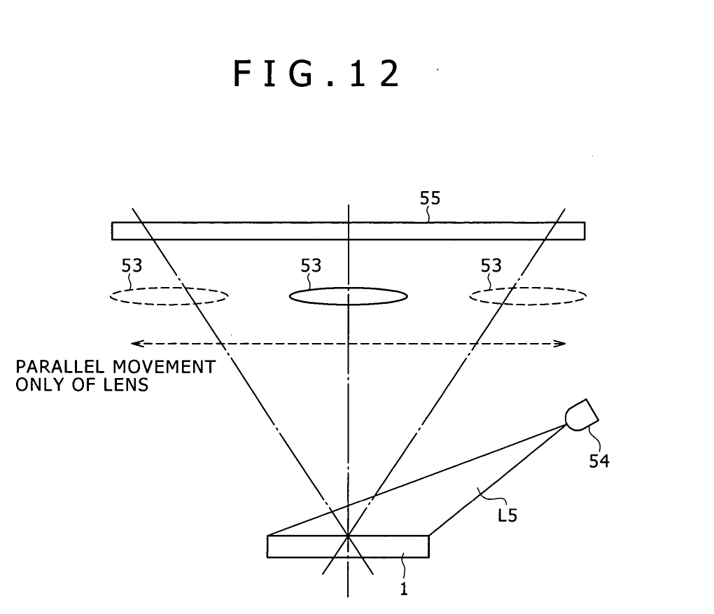

On the other hand, where the size of the imager 55 is sufficiently great, a configuration which moves only the image pickup lens system 53 as seen in FIG. 12 may be adopted.

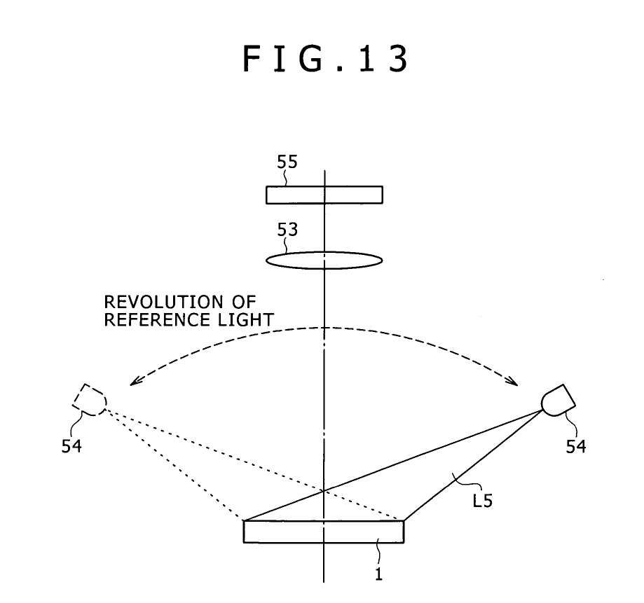

Alternatively, where such a configuration as described hereinabove with reference to FIG. 8B is used, the image pickup lens system 53 may be fixed while the light emitting element moving section 54a moves the light emitting element revolutionarily with respect to the hologram memory 1 so as to vary the angle of the reference light L5 for reading to be irradiated upon the hologram memory 1 as seen in FIG. 13.

4. Content Data to be Downloaded

Now, content data to be downloaded in the download system of the present embodiment is described.

In the foregoing description, audio content data is described as an example of content data. However, also various other content data are available in addition to the audio content data.

For example, the download system may be configured so as to download moving picture image data such as a video clip or still picture data as a still picture such as a photograph image.

Also text data of a novel, an essay, a thesis, a descriptive text, an advertisement and so forth can be adopted as content data of an object of downloading in the present embodiment. Also a computer program and an application program can be adopted as content data of an object of downloading in the present embodiment.

In other words, the content download system of the present embodiment can be formed as a system wherein various kinds of content data to be provided to users are recorded in a hologram memory 1 irrespective of the type of the content data such that the hologram memory 1 can be provided to a user using the hologram reproduction apparatus 50.

Then, for example, where moving or still picture data or text data are adopted as download contents, the hologram reproduction apparatus 50 may be configured such that it displays and outputs the substance of the download data on the display section 51.

Further, the object of provision of a content by downloading may be sales of content data, introduction of a content or various advertisements.

For example, where the content download system of the present embodiment is used as a system wherein music contents, video contents, text contents, program contents and so forth are sold to users, it should be configured such that a charging system to a user functions.

Naturally, the content download system may be configured so as to provide content data free of charge.

Or, the content download system may be configured such that only those persons who have a fixed qualification can download and utilize content data irrespective of whether or not the content data should be charged. In particular, the content download system may be configured such that, for example, content data as teaching materials are provided such that they can be utilized only by personnel or pupils of particular schools and content data as materials for business of a company can be utilized only by members of the company. The term “utilization” here includes reproduction of downloaded content data, transfer to another apparatus or the like.

On the other hand, where the content download system is used as a system for introduction or advertisement, it may be configured such that, for example, part of a music content, part of a moving picture content or the like is recorded on a hologram memory 1 such that it can be downloaded and reproduced by a user. In this instance, for example, introduction or advertisement of content data to be sold as a package medium 5 can be achieved.

Or, if the content download system of the present embodiment is configured such that content data such as text data, image data and music data for introduction, advertisement or explanation of an article can be downloaded as an advertisement for the sales of the article, then it functions as a system for advertisement.

Content data to be recorded on a hologram memory 1 may be prepared in accordance with any of the objects described above for which the content download system is configured.

Particularly, if the content download system is intended for the sales of a content itself, then content data of high quality is recorded on a hologram memory 1. For example, a music content of high quality sound is recorded on a hologram memory 1 so that the user can download the music content for pay.

On the other hand, if the content download system is intended for introduction, then data of low quality or part of data is recorded into a hologram memory 1. For example, a music content of degraded quality or a music content only of part of a tune may be downloaded so that a user can confirm the substance of the content. Or, a content as a computer software program whose functions are limited may be downloaded so that a user can preview the software program before it purchases the same.

5. Recording Forms of Content Data

While the content download system may have various objects in practical use as described above, the recording form of content data may be determined in accordance with the adopted object.

Particularly where the content download system is configured for downloading for pay, the content download system may be configured such that content data is encrypted or is furnished with a use restriction flag such that, even if the content data is downloaded into the hologram reproduction apparatus 50, the content data cannot be used as it is by the hologram reproduction apparatus 50.

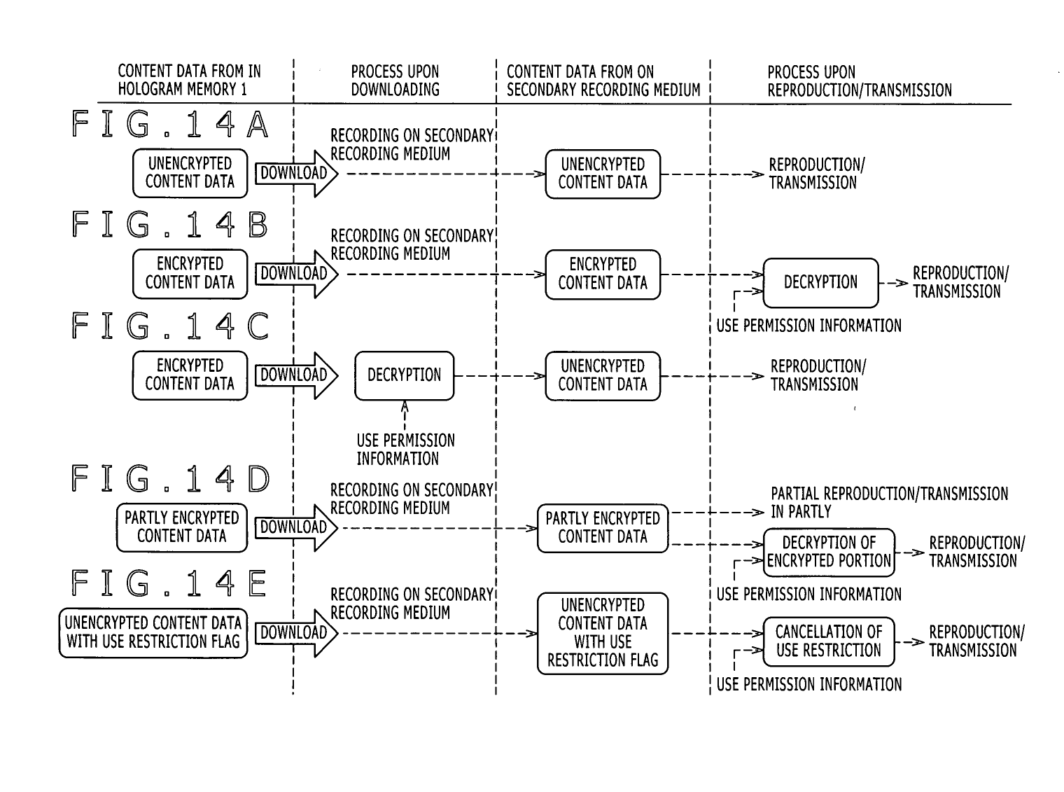

FIGS. 14A to 14E illustrate different examples of the form of content data recorded on a hologram memory 1, the process when content data is fetched into the hologram reproduction apparatus 50, a recording form on the secondary recording medium 90, and a process upon reproduction by the hologram reproduction apparatus 50 and upon transmission to the external apparatus 100.

It is to be noted that, while it is illustrated in FIGS. 14A to 14E that content data downloaded from the hologram memory 1 by the hologram reproduction apparatus 50 is recorded once on the secondary recording medium 90, the downloaded content data may otherwise be subject to the process upon reproduction/transmission without being recorded on the secondary recording medium 90.

FIG. 14A illustrates recording of content data in an unencrypted state on the hologram memory 1. In other words, no encryption process is executed at the data conversion step S2 of FIG. 2. In this instance, if content data downloaded from the hologram memory 1 is recorded on the secondary recording medium 90 by the hologram reproduction apparatus 50, then the unencrypted content data is recorded also on the secondary recording medium 90. Since the content data is recorded in an unencrypted state on the secondary recording medium 90, the hologram reproduction apparatus 50 can freely reproduce and output the content data or transmit the content data to the external apparatus 100.

The example of FIG. 14A is suitable for a content download system for downloading free of charge. In this instance, it is not necessarily required to add a content ID to content data of an object of downloading. In other words, basic data produced at the basic data production step S1-2 of FIG. 2 need not necessarily include a content ID.

It is to be noted that the hologram reproduction apparatus 50 side may arbitrarily perform encryption or the like for an object other than a charging object or a use restriction object on the download system. For example, upon transmission to the external apparatus 100, the hologram reproduction apparatus 50 may perform an encryption process for downloaded data.

FIG. 14B illustrates recording of content data in an encrypted state on the hologram memory 1. In other words, an encryption process is executed at the data conversion step S2 of FIG. 2. In this instance, if content data downloaded from the hologram memory 1 is recorded on the secondary recording medium 90 by the hologram reproduction apparatus 50, then the encrypted content data is recorded also on the secondary recording medium 90. Since the content data is recorded in an encrypted state on the secondary recording medium 90, the hologram reproduction apparatus 50 cannot freely reproduce or output the content data or transmit the content data as it is to the external apparatus 100 so as to be reproduced by the external apparatus 100. Therefore, as hereinafter described, it is necessary to acquire use permission information from the content use management system 6 shown in FIG. 1. Upon reproduction, the hologram reproduction apparatus 50 performs a decryption process for content data read out from the secondary recording medium 90 using a decryption key included in the use permission information. In particular, the reproduction processing section 76 or the data processing section 71 performs decryption of the content data to obtain decrypted content data. At this point of time, the content data can be reproduced and outputted or transferred to the external apparatus 100 so as to be reproduced.

The example of FIG. 14B is suitable for a content download system for downloading for pay or for a content download system wherein content data is provided for pay or free of charge but only to those users who have a particular qualification.

Also FIG. 14C illustrates recording of content data in an encrypted state on the hologram memory 1. In other words, an encryption process is executed at the data conversion step S2 of FIG. 2. In this instance, content data downloaded from the hologram memory 1 is decrypted and recorded on the secondary recording medium 90 by the hologram reproduction apparatus 50. The data processing section 71 of the hologram reproduction apparatus 50 performs a decryption process for encrypted content data fetched from the hologram memory 1 using a decryption key included in use permission information acquired from the content use management system 6. Then, the decrypted data is recorded on the secondary recording medium 90. Since the decrypted content data is recorded on the secondary recording medium 90, it is possible to thereafter read out and reproduce the content data from the secondary recording medium 90 or transfer the read out content data to the external apparatus 100 so as to be reproduced.

Also the example of FIG. 14C is suitable for a content download system for downloading for pay or for a content download system wherein content data is provided for pay or free of charge but only to those users who have a particular qualification.

FIG. 14D illustrates recording of partly encrypted content data on the hologram memory 1. In other words, in the encryption process executed at the data conversion step S2 of FIG. 2, only part of content data such as, for example, a highlight portion of music data is in an encrypted state.

In this instance, if content data downloaded from the hologram memory 1 is recorded on the secondary recording medium 90 by the hologram reproduction apparatus 50, then the partly encrypted content data is recorded also on the secondary recording medium 90. Since the content data is recorded in a partly encrypted state on the secondary recording medium 90, the hologram reproduction apparatus 50 can reproduce and output or transmit the other unencrypted portion of the content data as it is to the external apparatus 100. In order to reproduce the entire content including the encrypted portion, it is necessary to acquire use permission information from the content use management system 6. In the hologram reproduction apparatus 50, upon reproduction, the reproduction processing section 76 or the data processing section 71 performs a decryption process for content data read out from the secondary recording medium 90 using a decryption key included in the user permission information to obtain content data which is entirely in a decrypted state. At this point, the content data made possible to be reproduced and outputted, or transferred to the external apparatus 100 to be reproduced.

Also the example of FIG. 14D is suitable for a content download system for downloading for pay or for a content download system wherein content data is provided for pay or free of charge but only to those users who have a particular qualification. However, since part of a content can be reproduced, the content download system allows a user to enjoy or visually confirm part of content data before charging or the like is performed.

It is to be noted that, also where partly encrypted content data is recorded on a hologram memory 1 in this manner, the content data may otherwise be decrypted upon downloading similarly as in the example of FIG. 14C. In particular, the content download system may be configured such that, for example, a user who acquires a decryption key through a charging contract concluded in advance or a particular qualified person can record fully decrypted content data on the secondary recording medium 90 whereas, for any other user, unless a charging process or the like is performed, the content data is recorded while it partly remains in an encrypted form on the secondary recording medium 90 and consequently only part of the content data can be reproduced.

FIG. 14E illustrates recording of content data having use restriction flag information added thereto on the hologram memory 1. For example, at the data conversion step S2 of FIG. 2, although encryption of content data is not performed at the basic data production step S2-2 or the data processing step S1-3, use restriction flag information is added to the header information or the like. The use restriction flag information is used for decision by the system controller 61 of the hologram reproduction apparatus 50 such that, unless the use restriction flag is in a reset state, reproduction of the content data is inhibited.

In this instance, if the hologram reproduction apparatus 50 records content data downloaded from the hologram memory 1 on the secondary recording medium 90, then the content data with the use restriction flag information added thereto is recorded also on the secondary recording medium 90.

In particular, as far as the use restriction flag is not reset, the system controller 61 decides that reproduction of the content data recorded on the secondary recording medium 90 is inhibited, and does not allow a reproduction operation in response to an operation of the user to be performed. In order to allow execution of the reproduction, it is necessary to acquire use permission information from the content use management system 6. The use permission information includes use restriction cancellation information corresponding to the content ID, and the use restriction cancellation information is stored, for example, into the flash memory 65 or the like corresponding to the content ID.

If the user performs an operation to indicate reproduction outputting of content data, then the system controller 61 decides based on the content ID of the content data whether or not the use restriction cancellation information is acquired already. If the use restriction cancellation information is acquired already (for example, if the use restriction cancellation information is stored corresponding to the content ID in the flash memory 65), then the system controller 61 decides that the use restriction is cancelled and performs a reproduction outputting process. If the use restriction cancellation information corresponding to the content ID is not acquired as yet, then the system controller 61 does not execute the reproduction outputting process. A similar process is performed also with regard to a transmission process to the external apparatus 100.

Accordingly, similarly as in the case of encryption described hereinabove, only those users who acquire use permission information through charging or the like are permitted to use downloaded content data. Consequently, also the example of FIG. 14e is suitable for a content download system for downloading for pay or for a content download system wherein content data is provided for pay or free of charge but only to those users who have a particular qualification.

It is to be noted that, also where content data having use restriction flag information added thereto is recorded on a hologram memory 1 in this manner, if, upon downloading, the use restriction cancellation information corresponding to the content ID to be downloaded is acquired already, then the content data may be recorded on the secondary recording medium 90 with the use restriction flag information erased.

Although the recording forms of content data relating to encryption, decryption or presence/absence of use restriction flag information are described above, various other recording forms may be available. For example, content data for which both of addition of use restriction flag information and encryption are performed may be recorded on a hologram memory 1. Further, use restriction flag information may be added to part of content data while no use restriction is applied to the other part of the content data so that it can be enjoyed as a preview or the like. Further, part of content data may be encrypted while the other part is left in a non-encrypted state and besides use restriction flag information is added to the entirety or the part of the content data.

Also use restriction with respect to time may be applicable. For example, use restriction flag information is rendered effective after lapse of a predetermined period of time such as, for example, 30 days after downloading. In this instance, when the system controller 61 of the hologram reproduction apparatus 50 records download content data on the secondary recording medium 90, it places the date and hour of the downloading into the header or the like of the content data or registers the date and hour of the downloading in a coordinated relationship with the content ID into the flash memory 65. Then, within a predetermined period of time after the date and hour of the downloading, the system controller 61 permits reproduction of the content regardless of the use restriction flag information. However, after the term expires, the system controller 61 inhibits reproduction of the content data and cannot reproduce the content data unless the use restriction is cancelled with the use permission information.

Further, reproduction of content data to which use restriction flag information is added may be permitted although the number of times of use is restricted. In this instance, the system controller 61 increments the number of times of reproduction every time the content data is reproduced and stores the resulting number of times into the flash memory 65. Then, after reproduction of the content data is performed by a predetermined number of times, the system controller 61 inhibits reproduction of the content data and cannot reproduce the content data unless the use restriction is cancelled with the use permission information.

According to such use restrictions with respect to the time and the number of times of use as described above, for example, it is possible to set a previewing period for a user to make a decision for purchase of data.

6. Use Permission of a Downloaded Content

Now, a technique for permitting use in a case wherein encryption or use restriction flag information is used so that a download content cannot be used as it is, for example, in a case wherein the content download system is constructed as a system for downloading for pay, is described.

Basically, the user of the hologram reproduction apparatus 50 transmits use request information for content data downloaded by some technique to the content use management system 6 and receives use permission information from the content use management system 6.

Or, when the user wants to enjoy a download service, the user transmits use request information to the content use management system 6 in advance and receives use permission information from the content use management system 6.

Then, the use permission information is inputted to the hologram reproduction apparatus 50 so that such decryption or cancellation of the user restriction flag information as described above can be executed later thereby to make it possible to use downloaded content data.

The use request information to be transmitted to the content use management system 6 by the user includes, for example, a user ID, an apparatus ID of the hologram reproduction apparatus 50 and a content ID.

Meanwhile, the use permission information to be issued from the content use management system 6 to the user includes the user ID or the apparatus ID for specifying the user or the hologram reproduction apparatus 50 to which the permission is to be provided and the content ID for specifying the content whose use is to be permitted. The use permission information further includes a decryption key or use restriction cancellation information and so forth.

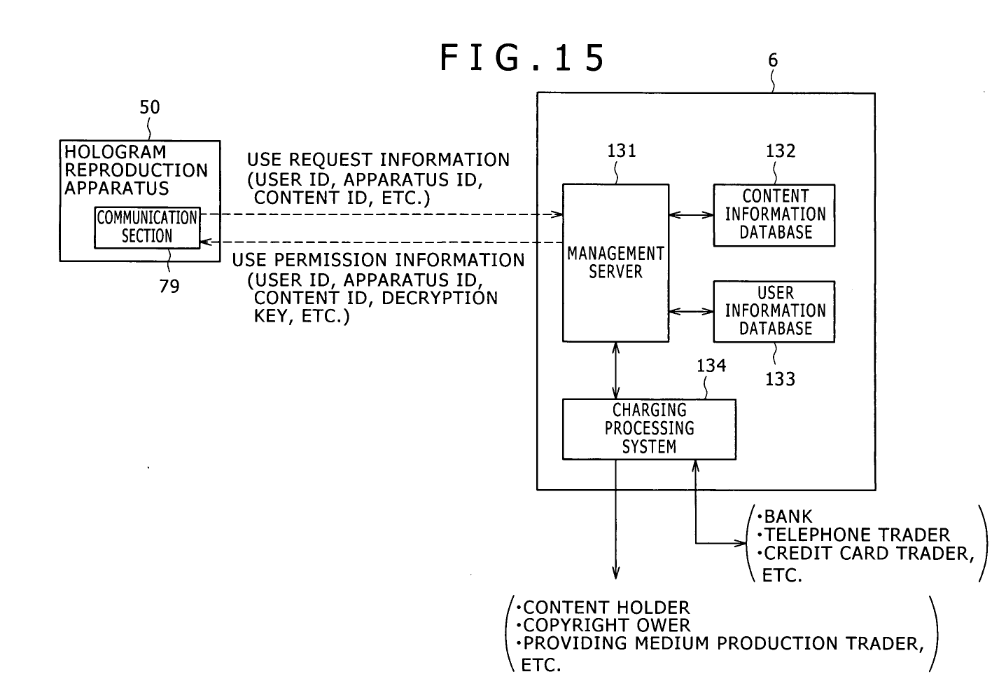

FIG. 15 illustrates an example of communication between the hologram reproduction apparatus 50 and the content use management system 6.

It is assumed here that the content use management system 6 is provided in order to perform a chargeable download service of a content, and an example of the configuration of the content use management system 6 in this instance is described first. Referring to FIG. 15, the content use management system 6 includes a management server 131, a content information database 132, a user information database 133 and a charging processing system 134.

The management server 131 performs a communication process with a hologram reproduction apparatus 50 owned by a user, management of the content information database 132 and the user information database 133 and issuance of an instruction to the charging processing system 134.

The content information database 132 retains information relating to various contents which can be provided to users, for example, through a hologram memory 1. For example, download charging information of a content, right holders such as a copyright owner, a producer and a content holder, encryption information, information relating to the substance of the content and so forth are stored in a coordinated relationship with each of content IDs applied to individual contents in the content information database 132.

The user information database 133 has recorded therein user information presented from each user, for example, under a download service contract with the user. For example, user specification information such as a user ID, an address and the name, a unique apparatus ID for specifying the hologram reproduction apparatus 50 and a bank account, a credit card number or a method of payment for a charging process for the user are recorded for individual uses as a database. Further, depending upon the charging processing form, the user information database 133 may have recorded therein a portable telephone number owned by the user or a contract number with an Internet provider. This is applied, for example, to a case wherein a claim for payment of a telephone charge or the like in which a download charge for contents is included is issued.

Further, a download history of each user, for example, a content ID or the date and hour of a downloaded content, a charge and so forth are successively recorded additionally every time.

Where a user wants to enjoy a download service, it would present information relating to the user to the content use management system 6 by a contract in advance. The content use management system 6 provides a user ID to the user who has the concluded contract and registers information of the user into the user information database 133.

The charging processing system 134 performs a charging process to a user and a process for payment to a right holder. For example, as the charging process to a user, the charging processing system 134 performs a claiming process for payment to the user, an automatic transfer process from a bank account of the user, a claiming process for payment by a credit card or a charging requesting process to a telephone trader or the like with whom the user has a contract. Meanwhile, the charging processing system 134 performs a remitting process to a content holder, a copyright owner (or a copyright management organization), a content providing medium producer or the like.

A user would use, for example, its hologram reproduction apparatus 50 to communicate with such a content use management system 6 as described above to perform a charge payment procedure for a content so that use of the content may be permitted. An example of a flow of processes in this instance is described below.

Here, it is assumed that, for example, the hologram reproduction apparatus 50 includes a communication section 79 as seen in FIG. 15 so that it can directly communicate with the content use management system 6. In particular, the hologram reproduction apparatus 50 includes the communication section 79 in addition to the components thereof described hereinabove with reference to FIG. 9 as seen in FIG. 15 so that the system controller 61 can transmit use request information through the communication section 79 in response to a transmission operation of the user.

It is assumed that, when the user uses the hologram reproduction apparatus 50 to download content data from the hologram memory 1, the hologram reproduction apparatus 50 records the content data, which is in an encrypted form, on the secondary recording medium 90, for example, in the form described hereinabove with reference to FIG. 14B.

In this instance, the user performs an operation for transmitting user request information through the operation section 52. Thereupon, the system controller 61 transmits use request information including, for example, a user ID, an apparatus ID and a content ID from the communication section 79 to the content use management system 6.

The user ID is provided to the user under a download service contract in advance, and, for example, the user inputs the user ID to the hologram reproduction apparatus 50 so that the user ID is stored into the flash memory 65 or the like in the hologram reproduction apparatus 50. Naturally, where the hologram reproduction apparatus 50 includes the communication section 79, the user ID may be transmitted to the hologram reproduction apparatus 50 through communication with the content use management system 6 when the contract is concluded so that the hologram reproduction apparatus 50 automatically stores the user ID into the flash memory 65.

The apparatus ID may be a serial number provided to the hologram reproduction apparatus 50 and stored into the flash memory 65 when the hologram reproduction apparatus 50 is produced or a like number.

Upon transmission of the use request information, the system controller 61 reads out the user ID and the apparatus ID from the flash memory 65 and further reads out a content ID added to the downloaded content data to produce use request information and transmits the produced use request information through the communication section 79.

In the content use management system 6 which receives the use request information, the management server 131 searches the user information database 133 based on the user ID to specify the user and further searches the content information database 132 based on the content ID to specify the content data whose purchase is requested by the user. Then, if the user and the content data are specified property, then the management server 131 instructs the charging processing system 134 to issue a request for a charging process for the purchased content data to the user. The charging processing system 134 performs a charging process to the user and then performs a remitting process to a right holder in accordance with the instruction.

Then, the management server 131 transmits use permission information to the hologram reproduction apparatus 50. The use permission information includes the content ID for specifying the content data whose use is to be permitted and a decryption key for the content data together with the user ID and the apparatus ID.

On the hologram reproduction apparatus 50 side, the communication section 79 receives the use permission information, and the system controller 61 stores the content ID and the encryption key in a coordinated relationship with each other, for example, into the flash memory 65. Thereafter, upon reproduction or transmission of the content data, the hologram reproduction apparatus 50 can execute decryption of the content data using the decryption key, and the user can freely use the content data.

It is to be noted that the procedure of the use process described above is a mere example, and various other procedures may be possible. For example, a unified decryption key may be used for content data on the system. In this instance, upon conclusion of a contract with a user, the decryption key is transmitted to the hologram reproduction apparatus 50 side. In other words, comprehensive use permission information including the decryption key is transmitted to the hologram reproduction apparatus 50 in advance. Consequently, upon downloading, decryption can be performed as seen from FIG. 14C. In such an instance, every time downloading is performed, the system controller 61 transmits a user ID, an apparatus ID and a content ID of downloaded content data through the communication section 79 to the content use management system 6, and the content use management system 6 performs a charging process for the user in response to the received information.

On the other hand, in the case of the form described hereinabove with reference to FIG. 14E, the content use management system 6 transmits use permission information including not the decryption key but use restriction cancellation information to the hologram reproduction apparatus 50.

Incidentally, while the hologram reproduction apparatus 50 in the example of FIG. 15 includes the communication section 79, the hologram reproduction apparatus 50 need not necessarily have a communication function.

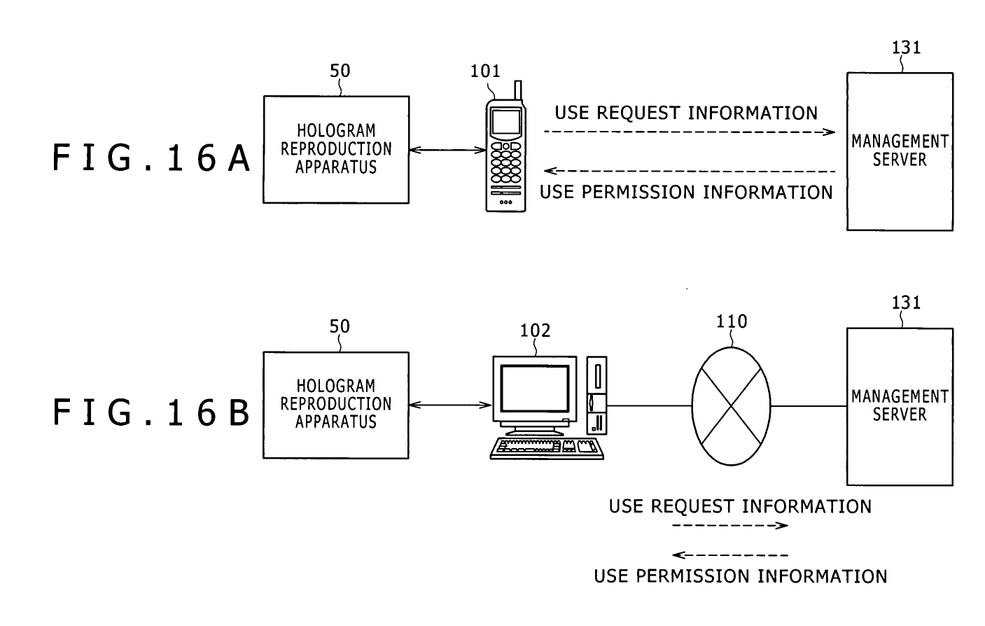

Different examples in this instance are shown in FIGS. 16A and 16B.

In the example of FIG. 16A, for example, when the user tries to issue a request for use of a content to the content use management system 6, the user connects a telephone apparatus such as a portable telephone set 101 and the hologram reproduction apparatus 50 to each other. Then, the communication function by the portable telephone set 101 is utilized to perform transmission and reception of use request information and use permission information to and from the management server 131.

On the other hand, in the example of FIG. 16B, for example, when the user tries to issue a request for use of a content to the content use management system 6, the user connects an apparatus which can communicate with a network such as a personal computer 102 and the hologram reproduction apparatus 50. Then, use request information and use permission information are transmitted to and received from the management server 131 through a network 110 such as the Internet.

The hologram reproduction apparatus 50 may utilize a communication function of an external apparatus to communicate with the content use management system 6 as in the cases of FIGS. 16A and 16B. Particularly where the portable telephone set 101 or the personal computer 102 is utilized, a charging process for content data to the user can be performed suitably by addition to the portable telephone charge or the Internet utilization charge.

Furthermore, where the portable telephone set 101 or the personal computer 102 is used, a connection to the hologram reproduction apparatus 50 may not be utilized.

For example, the user would manually input the content ID of the content data downloaded by the hologram reproduction apparatus 50 and the user ID to the portable telephone set 101 or the personal computer 102. The content ID should be able to be displayed on the display section 51 by the hologram reproduction apparatus 50.

The user would input the user ID provided to the user itself and the content ID and transmit them to the content use management system 6 through the portable telephone set 101 or the personal computer 102. In response to the transmission, the content use management system 6 transmits use permission information to the portable telephone set 101 or the personal computer 102. At this time, the portable telephone set 101 or the personal computer 102 displays a code number as a decryption key, use restriction cancellation information and the content ID included in the use permission information.

The user would manually input the displayed code number from the operation section 52 to the hologram reproduction apparatus 50. The hologram reproduction apparatus 50 stores the decryption key and use restriction cancellation information inputted thereto in a coordinated relationship with the content ID, for example, into the flash memory 65. Consequently, the hologram reproduction apparatus 50 can thereafter perform decryption or a use restriction cancellation process for the content data and can freely use the content data.

Further, use of content data may be performed not by the hologram reproduction apparatus 50 but by the portable telephone set 101 or the personal computer 102.

In particular, the hologram reproduction apparatus 50 transfers downloaded content data, for example, in an encrypted state or in a use-restricted condition to the portable telephone set 101 or the personal computer 102.

The transfer may be performed using the external interface 66 or may be performed using the secondary recording medium 90 which is formed as a portable recoding medium such that the secondary recording medium 90 is loaded into a medium drive of the portable telephone set 101 or the personal computer 102.

Then, transmission and reception of use request information and use permission information described above may be performed by the portable telephone set 101 or the personal computer 102 while use of content data such as reproduction based on the use permission information is performed on the portable telephone set 101 or the personal computer 102.

A content download system for downloading for pay can be implemented in accordance with the various examples described above. Naturally, a system wherein use of content data is permitted to only particular qualified persons as described above can be implemented similarly. For example, the content use management system 6 may perform an authentication process for a user ID transmitted thereto together with use request information from the user side and transmit use permission information including a decryption key or use restriction cancellation information to the user side if the authentication results in success.

It is necessary for such a download system as just described to perform communication of use request information and use permission information for permission of use based on a charging process or the like. However, since this communication does not involve communication of content data itself but involves communication of a very small amount of data such as an ID, a large-capacity high-speed communication line is not required. The communication can be implemented sufficiently by communication in which the portable telephone set 101 or the like is used as described hereinabove.

Further, if such a technique that an apparatus ID is included in the use permission information such that, upon reproduction on the user side or the like, content data cannot be reproduced if also the apparatus ID does not exhibit coincidence, is introduced, then it is possible to disable use of content data copied without permission on the user side after the content data is downloaded.

It is to be noted that information relating to communication of use request information and use permission information in the hologram reproduction apparatus 50 may be recorded not into the flash memory 65 but, for example, on a hard disk, into a memory card, on a secondary recording medium 90 such as an optical disk in the medium drive 73 or the like.

7. Mixed Recording of Content Data and Visual Recognition Image Data

In the embodiment described above, content data is recorded on the hologram memory 1. However, image data which can be visually recognized when the user looks at the hologram memory 1 itself may be recorded in a mixed manner in content data on the hologram memory 1. The image data are not data of an object of downloading but are of an image which enhances a design effect of the hologram memory 1 itself at all.

Here, description is given of another embodiment of the present invention is described wherein content data fetched by the hologram reproduction apparatus 50 and image data which can be recognized by the visual sense of a human being in a state wherein the image data are recorded on the hologram memory 1.

It is to be noted that, although it is described hereinabove that content data of an object of downloading may possibly be image data, in the following description, image data which are visually recognized by a person but do not make an object of downloading are referred to as “visual recognition image data” for distinction from ordinary image data. Further, the content data of an object of downloading in the following description are audio content data.

Here, when a hologram memory of the holographic stereogram type described hereinabove is to be formed, as hologram elements to be recorded as vertical zones on a hologram material, visual recognition image data are recorded partially and audio data to be downloaded as content data are recorded partially such that the audio data and the visual recognition image data are recorded in a mixed manner.

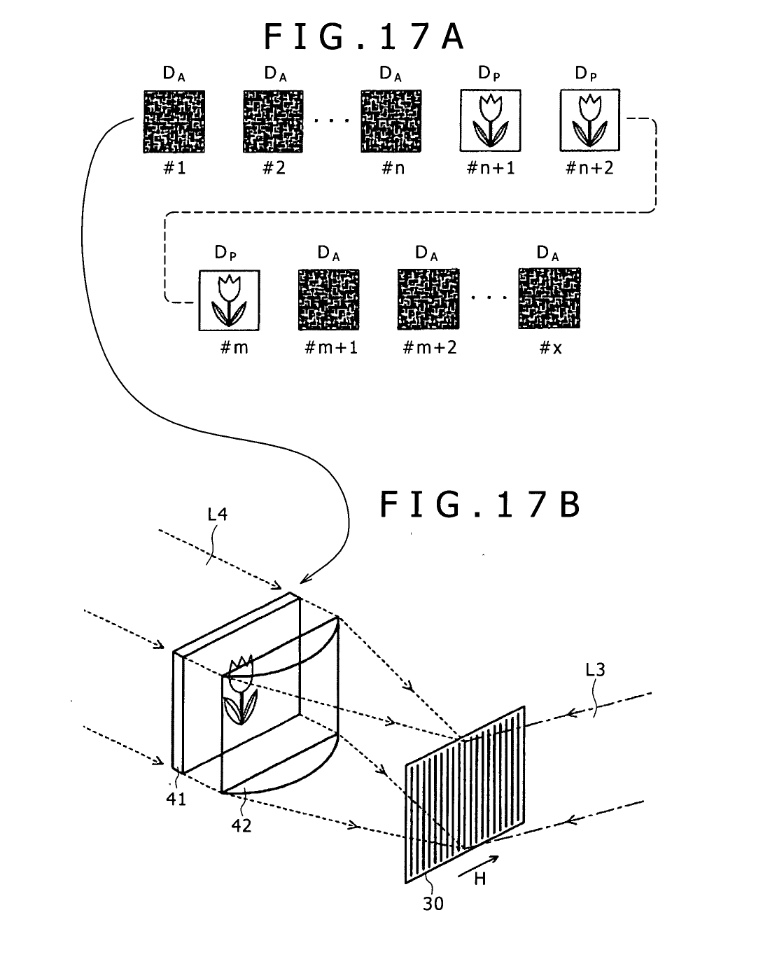

FIGS. 17A and 17B schematically illustrate that audio data and visual recognition image data are recorded in a mixed manner in a hologram memory.

As described hereinabove with reference to FIGS. 4A and 4B, also in this instance, object light L4 is illuminated on a display apparatus 41 while an image is displayed on the display apparatus 41. The object light L4 having transmitted through the display apparatus 41 makes object light which reflects the image displayed on the display apparatus 41, and this object light L4 is converged into a line extending in a vertical direction by a cylindrical lens 42 and then illuminated on the hologram material 30.

Interference fringes when the object light L4 converged into a line in this manner and the reference light L3 interfere with each other are recorded as a zone-like hologram element extending in a vertical direction as seen in FIG. 17B on the hologram material 30.

In order to successively produce such zone-like hologram elements, the hologram material 30 is fed step by step, for example, in the direction indicated by an arrow mark H and the image to be displayed on the display apparatus 41 is successively changed. Consequently, zone-like hologram elements as interference fringes are formed in a lattice-like fashion on the hologram material 30.

At this time, if images of a certain object picked up from various angles are successively displayed on the display apparatus 41 so as to be recorded individually as hologram elements, then the recorded hologram elements look as a three-dimensional image when they are visually recognized. In the present example, the images to be displayed on the display apparatus 41 include images derived from the visual observation image data and pattern images by which audio data of a download content are represented like a two-dimensional barcode.

In particular, if the display apparatus 41 successively displays two-dimensional pattern images based on audio data DA and images based on visual recognition image data DP in a predetermined order (#1 to #x) on the display apparatus 41 to successively form hologram elements on the hologram material 30 as seen in FIG. 17A, then the hologram material 30 on which the audio data DA and the visual recognition image data DP are recorded in a mixed manner can be formed. The hologram material 30 formed in this manner is used as a hologram master medium 91.

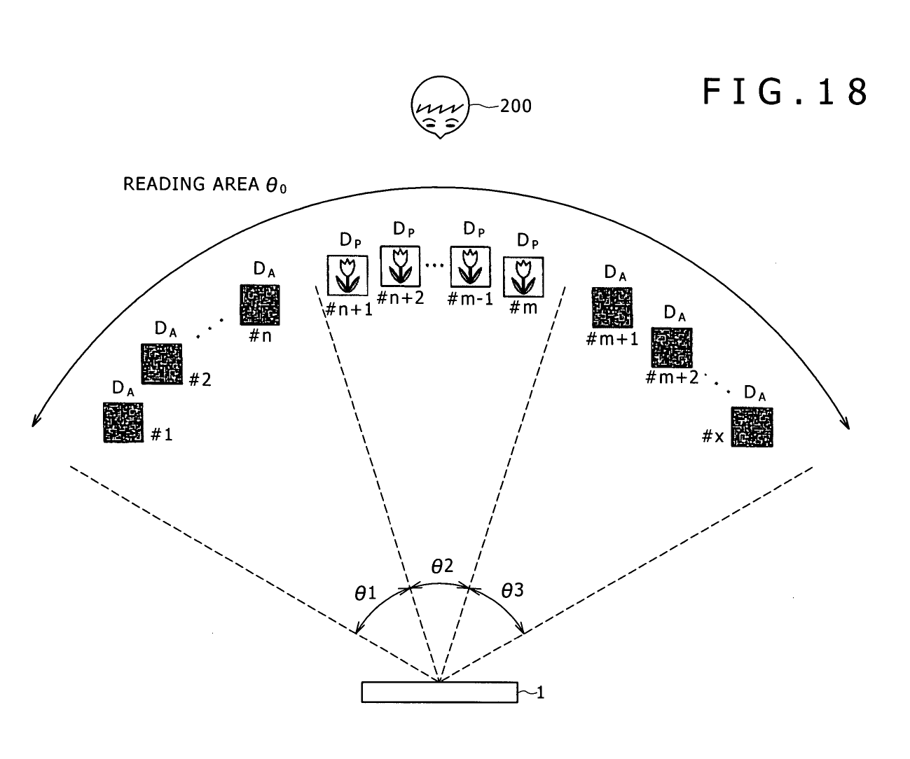

FIG. 18 illustrates a manner of hologram memory 1 duplicated from the hologram master medium 91 formed in such a manner as described above.

Data recorded as hologram elements appear as an image which can be visually recognized by a person on the hologram memory 1. In this instance, to the hologram memory 1, external light such as light from a light source disposed in a certain direction or natural light from therearound serves as reference light.

Where the audio data DA and the visual recognition image data DP are recorded in the order of #1 to #x as seen in FIG. 17A, image patterns of the audio data DA #1 to #n can be visually recognized from a range of an angle θ1 with respect to the hologram memory 1, for example, as seen in FIG. 18. Meanwhile, in another range of an angle θ2 which is a substantially front direction, images of the visual recognition image data DP of #n+1 to #m can be visually recognized. Further, from within a range of an angle θ3, image patterns of the audio data DA of #m+1 to #x can be visually recognized.

Although any image pattern derived from the audio data DA is not an image whose substance can be recognized in significance by a person like a two-dimensional barcode, images derived from the visual recognition image data DP can be recognized by a person 200 who faces the hologram memory 1 substantially from the front.

The image patterns derived from the audio data DA are read and processed by a hologram reproduction apparatus 50. The hologram reproduction apparatus 50 successively reads the images within the reading range θ0 shown in FIG. 2 by means of an image sensor. In particular, the hologram reproduction apparatus 50 successively reads image patterns derived from the audio data DA of #1 to #n, images of the visual recognition image data DP of #n+1 to #m and image patterns derived from the audio data DA of #m+1 to #x. For this reading, such an operation as described hereinabove with reference to any of FIGS. 10 to 13 may be performed. Then, the image patterns fetched as the image pickup data are decoded into data.

It is to be noted that, also in this instance, the hologram reproduction apparatus 50 reads also reproduction images of the visual recognition image data DP which are not an object of downloading. At this time, however, in a procedure of the data processing in the hologram reproduction apparatus 50, the visual recognition image data DP of #n+1 to #m are abandoned, but only data of recording units of the audio data DA decoded from the read out image patterns of #1 to #n and #m+1 to #x are extracted. Then, stream data as the audio data DA are produced from the data of the recording units.

Thus, the hologram memory 1 in this instance can record therein a sufficient amount of computer data such as audio data DA making the most of its characteristic of high density recording of a hologram memory. Furthermore, since the image itself can be recognized by the person 200 when the person 200 looks at the hologram memory 1 substantially from the front, the hologram memory 1 itself has a superior design performance.

Further, for example, where it is supposed to record audio data DA, if the audio data DA as music data are recoded as a download content and an artist photograph or a jacket image of the music is recorded as the visual recognition image data DP into the hologram memory 1, then the hologram memory 1 can be provided with high value added. For example, it is possible for the user to recognize an artist or the substance of music from an image which can be visually observed on the hologram memory 1 while the music itself (audio data DA) is successively read by the hologram reproduction apparatus 50.

It is to be noted that, naturally, if an image which can be visually observed within a certain angular range is used as the image of the visual recognition image data DP, the recording capacity for content data such as audio data DA and so forth decreases by an amount corresponding to the amount of the recorded visual recognition image data DP. However, conversely speaking, after a capacity necessary for recording of the audio data DA is set, the visual recognition image data DP should be recorded by an amount corresponding to the remaining capacity. In other words, within what angular range an effective image should be able to be observed in design (what recording capacity should be allocated to visual recognition image data DP) should be determined taking the amount of computer data to be recorded and the point of view on design into consideration.

Further, it is not always necessary to make it possible for an image derived from visual recognition image data DP to be visually observed in a direction from the front, and for example, it is a possible idea to make it possible for an image derived from visual recognition image data DP to be recognized only when the person 200 looks at the hologram memory 1 from an oblique direction.

Now, production of such a hologram memory 1 in which visual recognition image data and content data are recorded in a mixed state as described hereinabove is described.

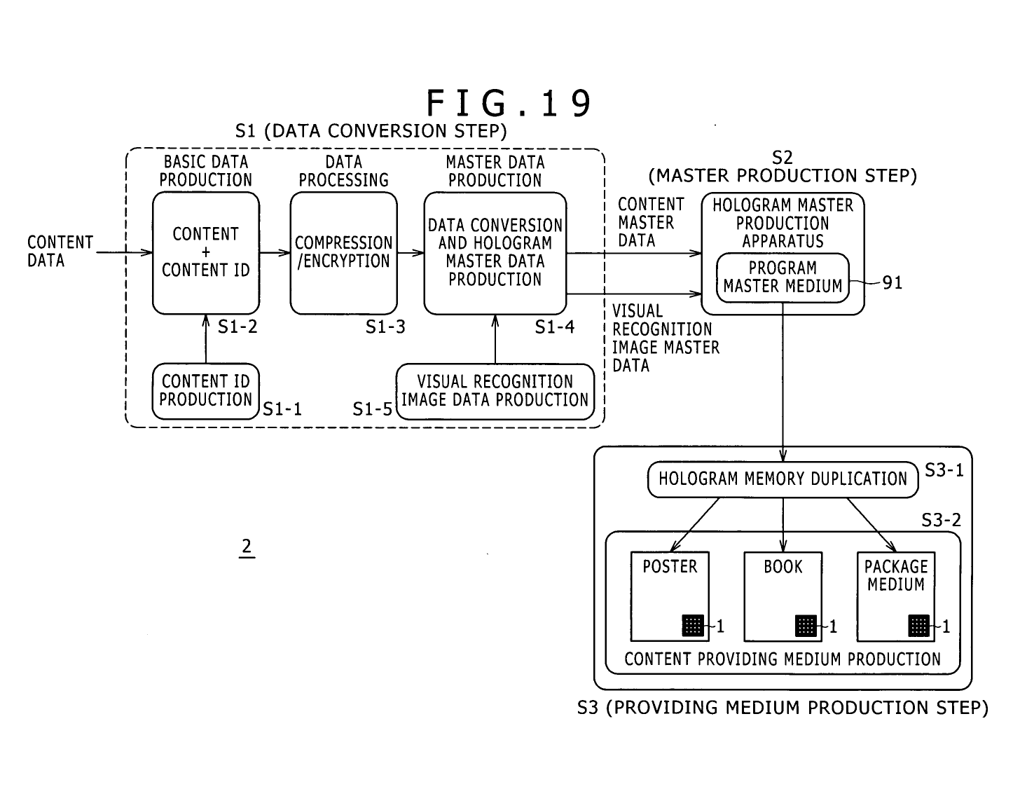

FIG. 19 illustrates a production procedure according to the content providing medium production system 2. It is to be noted that the production procedure illustrated in FIG. 19 includes all of the steps described hereinabove with reference to FIG. 2 and description of the common steps is omitted herein to avoid redundancy.

Referring to FIG. 19, the data conversion step S1 includes a visual recognition image data production step S1-5 in addition to the steps S1-1 to S1-4 described hereinabove. At the visual recognition image data production step S1-5, image data to be recorded as visual recognition image data DP are produced. For example, visual recognition image data DP of a plurality of images corresponding to a plurality of elementary holograms to be recorded on a hologram material 30 are produced by such a technique as image pickup of a certain object or a computer graphic technique. Where a three-dimensional image is to be used as an image to be recorded on and visually recognized from a hologram memory 1, the visual recognition image data DP of #n+1 to #m described hereinabove are formed from a parallax image train.

Then at the master data production step S1-4, the audio data after the data processing step S1-3 is performed are converted into two-dimensional pattern images to produce content master data while the visual recognition image data DP produced at the visual recognition image data production step S1-5 are converted into visual observation image master data. Then, the content master data and the visual recognition image master data produced in this manner are signaled.

It is to be noted that, while the hologram memory 1 in which the audio data DA and the visual recognition image data DP are recorded in a mixed state is produced, it is necessary to make it possible to distinguish the audio data DA and the visual recognition image data DP from each other after the hologram reproduction apparatus 50 fetches reproduction images from the hologram memory 1.

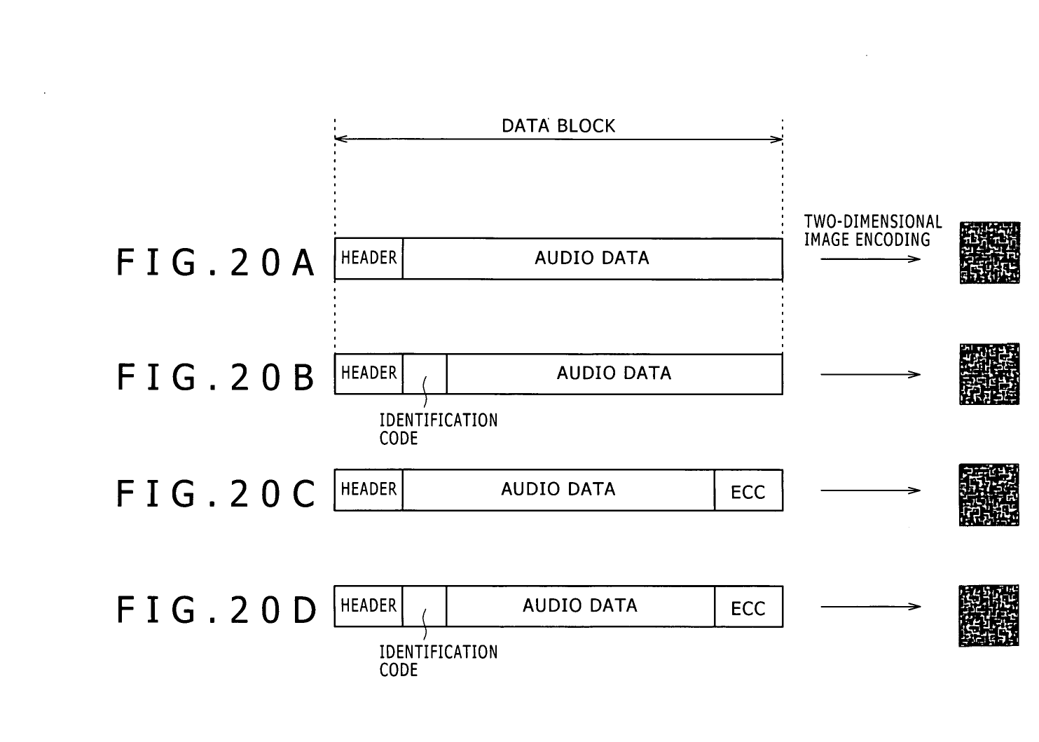

One of the techniques for such distinction is to add an identification code as seen in FIGS. 20B and 20D to a configuration of a data block of audio data DA produced at the data conversion step S1. The identification information is code information for the identification of a hologram element recorded on the hologram memory 1 from visual recognition image data DP, that is, code information which indicates that the hologram element is a data block in which audio data DA are recorded. Those data blocks to which such an identification code as just described is added are converted into two-dimensional pattern images to produce master data of the audio content.

It is to be noted that, while data blocks shown in FIGS. 20A and 20C have configurations same as those of the data blocks described hereinabove with reference to FIGS. 3A and 3B, respectively, even if such an identification code as described above is not added in this manner, it is possible for the hologram reproduction apparatus 50 side to distinguish the audio data DA and the visual recognition image data DP from each other.

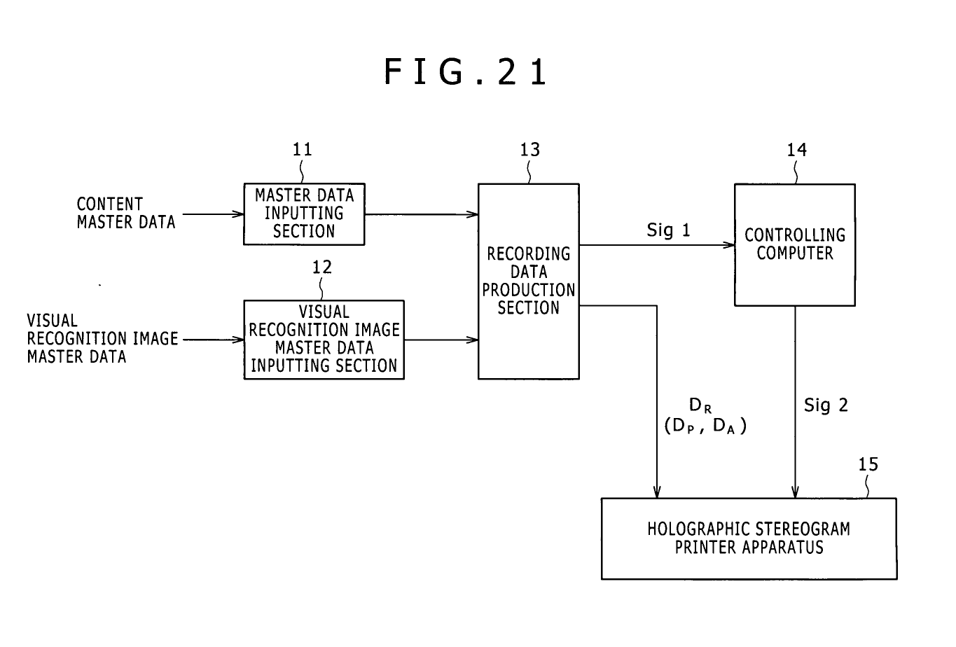

A hologram master production apparatus for producing a hologram master medium 91 at the master production step S2 is shown in FIG. 21.

Referring to FIG. 21, the hologram master production apparatus shown has a basically similar configuration to that described hereinabove with reference to FIG. 6 except that it additionally includes a visual recognition image master data inputting section 12 such that visual recognition image master data produced at the data conversion step S1 described hereinabove are inputted.

The recording data production section 13 controls the order of pattern image data based on the audio data DA inputted to and supplied from the content master data inputting section 11 and the visual recognition image data DP supplied from the visual recognition image master data inputting section 12, for example, among #1 to #x illustrated in FIG. 17A and successively supplies the data in the controlled order to the holographic stereogram printer apparatus 15. The controlling computer 14 and the holographic stereogram printer apparatus 15 operate similarly to those described hereinabove with reference to FIGS. 6, 7A and 7B.

In particular, in the holographic stereogram printer apparatus 15, a plurality of images for exposure based on recording data DR outputted from the recording data production section 13 are successively displayed on the display apparatus 41 and the shutter 32 is opened for every image so that the images are successively recorded as rectangular elementary holograms on the hologram material 30. At this time, since the hologram material 30 is successively fed by a one-elementary hologram distance for every one image, the elementary holograms are juxtaposed with each other in the transverse direction. Consequently, as the visual recognition image data DP, a plurality of images including, for example, parallax information in the transverse direction are recorded as a plurality of transversely continuing elementary holograms on the hologram material 30, and a holographic stereogram having a parallax in the transverse direction is obtained. Also image patterns derived from the audio data DA are recorded as a plurality of elementary holograms continuing in the transverse direction similarly.

Then, the hologram material 30 on which the recording data DR are recorded by the holographic stereogram production system is used as the hologram master medium 91 in FIG. 19, and the hologram master medium 91 is used to perform the providing medium production step S3 including the hologram duplication step S3-1 and the content providing medium production step S3-2.

On a hologram memory 1 provided on a content providing medium such as a poster or a book or a hologram memory 1 as a package medium produced in such a manner as described above, the user can visually recognize images derived from the visual recognition image data DP, and consequently, the hologram memory 1 is provided with an enhanced design performance.

It is to be noted that, while, upon downloading by means of the hologram reproduction apparatus 50, all of reproduction images within the reading range θ0 of FIG. 18 are fetched as image pickup data from the hologram memory and accumulated into the DRAM 64, also reproduction images of visual recognition image data DP in this instance are included as image pickup data.

Therefore, the data processing section 71 discriminates whether each of the image pickup data accumulated in the DRAM 64 is image pickup data of a reproduction image of a two-dimensional image pattern of a data block including audio data DA or a reproduction image of image data DP, and performs also a process of abandoning the image pickup data if the image pickup data is a reproduction image of image data DP.

For example, where the data block has the configuration of FIG. 20B or 20D, the data processing section 71 can discriminate whether the image pickup data is a reproduction image of audio data DA or a reproduction image of visual recognition image data DP depending upon whether or not the identification code is included in the data block.

On the other hand, where the data block has the configuration of FIG. 20C or 20D, the display apparatus 41 may discriminate that the image pickup data is a reproduction image of audio data DA if an error correction process can be performed correctly using an ECC parity but the image pickup data is a reproduction image of visual recognition image data DP if such an error correction process as mentioned above cannot be performed correctly.

Further, where the data block does not include the identification code as in the case of the data block of FIG. 20A nor includes an error correction code, the data processing section 71 may use a technique of confirming the format or the substance of data of the data block to perform a discrimination. For example, if certain information having predetermined significance is included in the header information, then the data processing section 71 may adopt the data block as a data block of audio data DA. Further, although, in order to join audio data extracted from data blocks together to produce audio stream data, data block numbers of the data blocks must be confirmed, since visual recognition image data DP do not include data block numbers representative of order numbers in the stream data, the data processing section 71 may exclude data obtained from reproduction images of visual recognition image data DP.

As described above, since visual recognition image data and content data are recorded in a mixed manner on a hologram memory 1, the hologram memory 1 can record therein a sufficient amount of computer data of an object of downloading such as audio data DA making the most of the characteristic of high density recording of the hologram memory 1. Furthermore, since a person can recognize the image itself when the person looks at the hologram memory 1 itself, the hologram memory 1 itself can be provided with a superior design performance, and also a content providing medium to which the hologram memory 1 is applied can be provided with a high design performance and high value added. It is to be noted that visual recognition image data may be image data from which a three-dimensional image is derived as a reproduction image or not a three-dimensional image but a two-dimensional image may be derived as a reproduction image.

Further, the hologram reproduction apparatus 50 side can download content data correctly by successively fetching reproduction images observed within a predetermined angular range on the hologram memory 1 and extracting image patterns derived from content data.

It is to be noted that, while, in the example shown in FIG. 18, reproduction images of visual recognition image data DP can be visually observed substantially from the front with respect to the hologram memory 1 by a person, this arrangement allows the person to observe the reproduction images of the visual recognition image data DP more readily and is suitable for enhancement of the design performance when the reproduction images are visually recognized. However, depending upon the situation or purpose of use, the hologram memory 1 may be formed otherwise such that reproduction images of visual recognition image data DP can be observed not from the front but from an oblique direction.

Further, if the hologram memory 1 is configured such that reproduction images of image patterns derived from content data are observed within the range of the angle θ2 in FIG. 18, that is, from the front of the hologram memory 1, then the angular range of scanning by the scanning mechanism 74 of the reproduction apparatus 50 can be set to a narrow range, which provides an advantage that the configuration can be simplified suitably.

8. Modifications

While preferred embodiments of the present invention are described above, according to the present invention, various modifications are possible.

The hologram memory 1 is not limited to that of the holographic stereogram type, but the present invention can be applied also to hologram memories of any other recording type.

Further, while various techniques can be applied to implementation of increase of the capacity of a hologram recording medium such as, for example, wavelength multiplexing, angle multiplexing, shift multiplexing and multi-value recording, hologram memories which adopt any of the techniques mentioned may be used for the hologram memory 1.

Further, the recording method or type for the hologram memory 1 may be selected in accordance with the amount of content data to be recorded.

The configuration of the hologram reproduction apparatus 50 is not limited to that described hereinabove with reference to FIG. 9. Also reproduction outputting or transmission outputting of content data downloaded from the hologram memory 1 may assume various forms.

Further, the hologram reproduction apparatus 50 itself may not include a function of reproducing downloaded content data. In this instance, the content data may be transferred to an external apparatus 100 by communication through the external interface 66 or by movement of the secondary recording medium 90 and reproduced by the external apparatus 100 side.

According to the present invention, content data can be downloaded directly from a hologram memory provided on a content providing medium by a download apparatus. In other words, according to the present invention, there is an advantage that the user can acquire content data readily if the user possesses the download apparatus without the necessity for provision of high-speed network environments or a personal computer system.

Further, since a paper medium such as a poster or a book is used as a content providing medium and a hologram memory is provided on the paper medium, when the user sees an introduction of the content data on the poster or the like, if the user wants to acquire the content data, then the user can immediately download and acquire the content data. In other words, the user can acquire the content data at an opportunity at which the user takes note of the content data naturally and need not use its labor and time to intentionally search for the content data in a shop or on Internet web sites later. Also to the provider side of content data, use of such a paper medium as described above is useful in that the opportunity at which the content data can be provided to users or is purchased by users increases.

Further, if the hologram memory has recorded therein not only content data but alto image data which can be recognized by the visual sense of a human being in a state wherein the image data is recorded on the hologram memory, then the effect on the visual sense and the effect of the design of the hologram memory and the content providing medium which includes the hologram memory can be enhanced. In this instance, if the download apparatus acquires, upon data reading out, only the content data from such a hologram memory as just described, then the download apparatus can perform suitable apparatus operation.

If the download apparatus additionally includes a reproduction outputting section, then the download apparatus itself can output content data downloaded and recorded on a secondary recording medium. Consequently, the user can enjoy, for example, a downloaded music content very readily.

Further, if the download apparatus additionally includes a transmission section, then downloaded content data can be transferred to an external apparatus so as to be utilized on the external apparatus.

Furthermore, if the download apparatus can perform encryption of content data, decryption based on use permission information, permission of reproduction outputting and/or permission of transmission, then appropriate processes suitable for a content download system for downloading for pay can be implemented.

While preferred embodiments of the present invention have been described using specific terms, such description is for illustrative purpose only, and it is to be understood that changes and variations may be made without departing from the spirit or scope of the following claims.

What is claimed is:

1. A content distribution system, comprising:
a content providing medium having a hologram memory in which content data is recorded as distribution data; and
an acquisition apparatus for reading out and acquiring the distribution data from said hologram memory provided on said content providing medium.

2. The content distribution system according to claim 1, further comprising
a use permission distribution apparatus for distributing, where user permission is required for the use of the content data to be distributed, use permission of the content data,
said acquisition apparatus including a connection section for connecting said acquisition apparatus to said use permission distribution apparatus such that said acquisition apparatus acquires the use permission of the content to be reproduced from said use permission distribution apparatus before the content is reproduced.

3. The content distribution system according to claim 1, wherein said hologram memory provided on said content providing medium has recorded thereon not only the content data but also image data which can be recognized by a visual sensation of a human being in a state wherein the image data is recorded in said hologram memory.

4. The content distribution system according to claim 3, wherein said acquisition apparatus acquires only the content data when reading out of the data is performed from said hologram memory in which the content data and the image data are recorded.

5. A content providing medium production method, comprising the steps of:
converting content data into hologram master data;
producing a master recording medium using the hologram master data; and
producing providing medium, for duplicating a hologram memory from the master recording medium and providing a predetermined content providing medium with the fabricated hologram memory.

6. The content providing medium production method according to claim 5, wherein, at the data conversion step, content data in a compressed form are converted into the hologram master data.

7. The content providing medium production method according to claim 5, wherein, at the data conversion step, content data in an encrypted form are converted into the hologram master data.

8. The content providing medium production method according to claim 5, wherein, at the data conversion step, not only content data as an object of downloading but also image data which is an object of visual recognition and has the substance which can be recognized by the human being on said hologram memory are converted into the hologram master data.

9. The content providing medium production method according to claim 5, wherein the content providing medium is a paper medium.

10. A content acquisition apparatus for acquiring content data from a content providing medium having a hologram memory in which the content data is recorded as distribution data, comprising:
reference light outputting means for outputting reading out reference light to said hologram memory on the content recording medium;
detection means for detecting, in a state wherein the reading out reference light is applied to said hologram memory by said reference light outputting means, a reproduction image based on data recorded in said hologram memory; and
reproduction processing means for reproducing a data string as the content data from the reproduction image detected by said detection means.

11. The content acquisition apparatus according to claim 10, further comprising recording means for a secondary recording medium, said recording means recording the content data reproduced by said reproduction processing means on the secondary recording medium.

12. The content acquisition apparatus according to claim 11, further comprising reproduction outputting means for reproducing and outputting content data, said reproduction outputting means reproducing and outputting the content data recorded on the secondary recording medium.

13. The content acquisition apparatus according to claim 12, wherein the reproduction and outputting of the content data by said reproduction outputting means is executed in accordance with use permission information inputted thereto.

14. The content acquisition apparatus according to claim 10, further comprising
transmission means for transmitting content data to an external equipment, said transmission means transmitting the content data reproduced by said reproduction processing means to an external equipment.

15. The content acquisition apparatus according to claim 14, wherein the transmission of the content data by said transmission means is executed in accordance with use permission information inputted thereto.

16. The content acquisition apparatus according to claim 10, further comprising
decryption means for performing a decryption process for content data which is in an encrypted form.

17. The content acquisition apparatus according to claim 16, wherein the decryption process by said decryption means is executed using use permission information.

18. A content acquisition method for acquiring content data from a content providing medium having a hologram memory in which the content data is recorded as distribution data, comprising the steps of:
detecting, in a state wherein reading out reference light is applied to said hologram memory on said content providing medium, a reproduction image of data recorded in said hologram memory; and
reproducing a data string as the content data from the reproduction image detected at the detection step.

19. A content acquisition apparatus for acquiring content data from a content providing medium having a hologram memory in which the content data is recorded as distribution data, comprising:
a reference light outputting section for outputting reading out reference light to said hologram memory on the content recording medium;
a detection section for detecting, in a state wherein the reading out reference light is applied to said hologram memory by said reference light outputting section, a reproduction image based on data recorded in said hologram memory; and
a reproduction processing section for reproducing a data string as the content data from the reproduction image detected by said detection section.
